(19) United States
(12) Patent Application Publication
(10) Pub. No.: US 2011/0170864 A1
(43) Pub. Date: Jul. 14, 2011

(54) INTERFACE DEVICE, DEMULTIPLEXING METHOD, AND MULTIPLEXING METHOD

(75) Inventors: Shigeo TANI, Osaka (JP); Hidenori Kiuchi, Osaka (JP); Takashi Umegaki, Osaka (JP); Ryoji Azumi, Osaka (JP); Shigehisa Sakahara, Osaka (JP)

(73) Assignee: FUJITSU LIMITED, Kawasaki-shi (JP)

(21) Appl. No.: 12/987,672

(22) Filed: Jan. 10, 2011

(30) Foreign Application Priority Data
Jan. 14, 2010 (JP) 2010-006006

(51) Int. Cl. H04J 14/00

(52) U.S. Cl. 398/43

(57) ABSTRACT

An interface device for demultiplexing, from a first frame in a transport network, a plurality of second frames multiplexed into the first frame is provided. The interface device includes an extractor configured to extract a plurality of data groups to constitute the first frame, and a second frame generator configured to create the second frames based on the plurality of data groups extracted by the extractor.

### CROSS-REFERENCE TO RELATED APPLICATION

This application is based upon and claims the benefit of priority of the prior Japanese Patent Application No. 2010-006006, filed on Jan. 14, 2010, the entire contents of which are incorporated herein by reference.

### FIELD

The embodiments discussed herein are related to a method for multiplexing signals in an Optical Transport Network (OTN).

### BACKGROUND

In recent years, broadband networks have become common, and the traffic of image signals as well as audio signals increases in networks. Therefore, a demand for high-speed and large-capacity networks has been raised.

In order to respond to such a demand, reviews have been conducted on networks to transmit data effectively. As a result, an OTN is standardized which is suitable for a communication according to Dense Wavelength Division Multiplexing (DWDM) in a backbone network (see ITU-T G.709).

For this reason, many transport nodes in networks currently used are provided with network interfaces conforming to such an OTN.

In the beginning, the following three types of formats are defined as the OTN: 2.5 Gbps Optical channel Transport Unit (OTU) 1; 10 Gbps OTU2; and 40 Gbps OTU3.

However, in order to deal with various signals used in Ethernet (registered trademark) or the like, a variety of standards are being standardized. For example, the addition of 100 Gbps OTU4, 1.25 Gbps OTU0, and the like is being considered, and a new mapping method is being considered.

It is, thus, necessary that transport nodes having network interfaces conforming to the OTN meet the new standards defined as described above.

The following technology has been proposed as a technology for handling signals ranging from low-speed signals to high-speed signals. According to the technology, a standardized OTN frame is applied fixedly irrespective of signal types accommodated therein, and a signal is accommodated in a standardized SDH/SONET frame corresponding thereto (see Japanese Laid-open Patent Publication No. 2008-227995).

In the meantime, FIG. 25 illustrates an example of the configuration of an interface card 10 for a network interface conforming to an OTN. With the interface card 10, for example, an optical signal of Very Short Reach (VSR), which is a short distance optical communication standard, is converted into an electric signal by a VSR optical module 11, an OTN Framer (FEC) module 12 performs a code error correction, and then, an OTN Framer (Demux/Mux) module 13 performs multiplexing/demultiplexing. FIGS. 26 and 27 respectively illustrate examples of general configurations of a demultiplexer and a multiplexer for the OTN, the combination of which corresponds to the OTN Framer (Demux/Mux) module 13.

According to the configurations of the general demultiplexer 20 and the general multiplexer 30 for the OTN illustrated in FIGS. 26 and 27 respectively, multiplexing and demultiplexing are performed at an Optical Data Unit (ODU) level denoted by ODU1, ODU2, or the like in order to meet the OTN standards.

Such ODU is capable of containing, therein, ODU having a lower level than the subject ODU. As illustrated in FIGS. 28-30, for example, ODU3 is capable of containing the ODU1 and the ODU2 therein, and the ODU2 is capable of containing the ODU1 therein. In addition, ODU0, which corresponds to new standards, may be contained in any of the ODU3-ODU1. The demultiplexer 20 illustrated in FIG. 26 is, therefore, provided with an ODTU23-Dmux module which demultiplexes the ODU2 from the ODU3, an ODTU13-Dmux module which demultiplexes the ODU1 from the ODU3, an ODTU03-Dmux module which demultiplexes the ODU0 from the ODU3, and so on. The demultiplexer 20, thereby, generates a signal having a desired format in the end.

The multiplexer 30 illustrated in FIG. 27 is provided with an ODTU01-Mux module which generates ODU1 from ODU0, an ODTU02-Mux module which generates ODU2 from ODU0, and so on.

In the case where a multiplexing process or a demultiplexing process is performed by sequentially performing conversion processes at all the ODU levels as described above, in order to deal with a new standardized ODU level, a new processing circuit is required to perform a conversion process between the new standardized ODU level and each of the existing ODU levels.

This complicates the processes and increases the scale of the circuit. Thereby, the development period is lengthened, which sometimes makes it difficult to release the products to the market timely.

### SUMMARY

According to an aspect of the invention (embodiments), an interface device for demultiplexing, from a first frame in a transport network, a plurality of second frames multiplexed into the first frame is provided. The interface device includes an extractor configured to extract a plurality of data groups to constitute the first frame, and a second frame generator configured to create the second frames based on the plurality of data groups extracted by the extractor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the functional configuration of a demultiplexer;

FIG. 2 is a diagram illustrating an example of the configuration of a Demux module;

FIG. 3 is a diagram illustrating an example of the detailed configuration of an ODU3-Demux module;

FIG. 4 is a diagram illustrating an example of data signals fed into an ODU3-Demux module and TS signals fed out therefrom;

FIG. 5 is a diagram illustrating an example as to how ODU3 data is arranged in a data signal;

FIG. 6 is a diagram illustrating an example of the configuration of an ODU2-Demux module;

FIG. 7 is a diagram illustrating an example of data signals fed into an ODU2-Demux module and TS signals fed out therefrom;

FIG. 8 is a diagram illustrating an example of the configuration of a TS-change module;

FIG. 9 is a diagram illustrating an example of the detailed configuration of a cross-connect processing portion;

FIG. 10 is a diagram illustrating an example of the structure and details of H/S information;

FIG. 11 is a diagram illustrating the first specific example of signals in a demultiplexing process;

FIG. 12 is a diagram illustrating the second specific example of signals in a demultiplexing process;

FIG. 13 is a diagram illustrating the third specific example of signals in a demultiplexing process;

FIG. 14 is a diagram illustrating the fourth specific example of signals in a demultiplexing process;

FIG. 15 is a diagram illustrating the fifth specific example of signals in a demultiplexing process;

FIG. 16 is a diagram illustrating an example of the details of H/S information set in TS-change modules and SEL modules;

FIG. 17 is a diagram illustrating an example of the functional configuration of a multiplexer;

FIGS. 18A and 18B are diagrams illustrating an example of the detailed configuration of a multiplexer;

FIG. 19 is a diagram illustrating an example of the configuration of an ODU1-Mux module;

FIG. 20 is a diagram illustrating an example of the flow of TS signals in a multiplexer;

FIG. 21 is a diagram illustrating an example of a list in which TS signals fed into the SEL modules are associated with TS signals to be outputted;

FIG. 22 is a diagram illustrating an example of a positional correspondence table of TS's and ODU signals;

FIG. 23 is a diagram illustrating the first specific example of a data walk-through in a multiplexer;

FIG. 24 is a diagram illustrating the second specific example of a data walk-through in a multiplexer;

FIG. 25 is a diagram illustrating an example of the configuration of an interface card;

FIG. 26 is a diagram illustrating an example of the configuration of a general demultiplexer;

FIG. 27 is a diagram illustrating an example of the configuration of a general multiplexer;

FIG. 28 is a diagram illustrating a mapping method for ODU1 and ODU2;

FIG. 29 is a diagram illustrating a mapping method for ODU1, ODU2, and ODU3;

FIG. 30 is a diagram illustrating a method for combining ODU1 and ODU2 into ODU3;

FIG. 31 is a diagram illustrating the configuration of an OTU frame;

FIG. 32 is a diagram illustrating the configuration of an OTN frame;

FIG. 33 is a diagram illustrating the configuration of an OPU frame;

FIG. 34 is a diagram illustrating a method for storing TS's into OPU2;

FIG. 35 is a diagram illustrating a method for storing TS's into OPU3; and

FIG. 36 is a diagram illustrating a multiplex relationship of ODU0-ODU3.

### DESCRIPTION OF EMBODIMENTS

Preferred embodiments of the present invention will be explained with reference to accompanying drawings.

### First Embodiment

A demultiplexer 100 according to the first embodiment performs a demultiplexing process on the basis of Tributary Slot (hereinafter, referred to as a “TS”) instead of performing a demultiplexing process for each ODU level, e.g., demultiplexing ODU2 from ODU3, and demultiplexing ODU1 from ODU3.

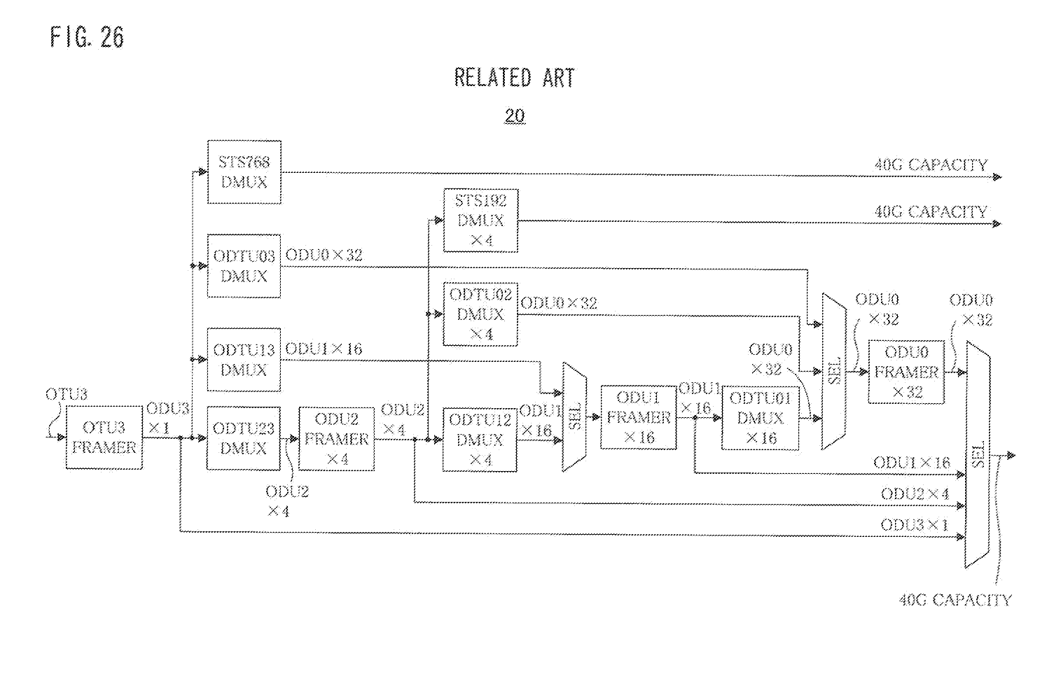

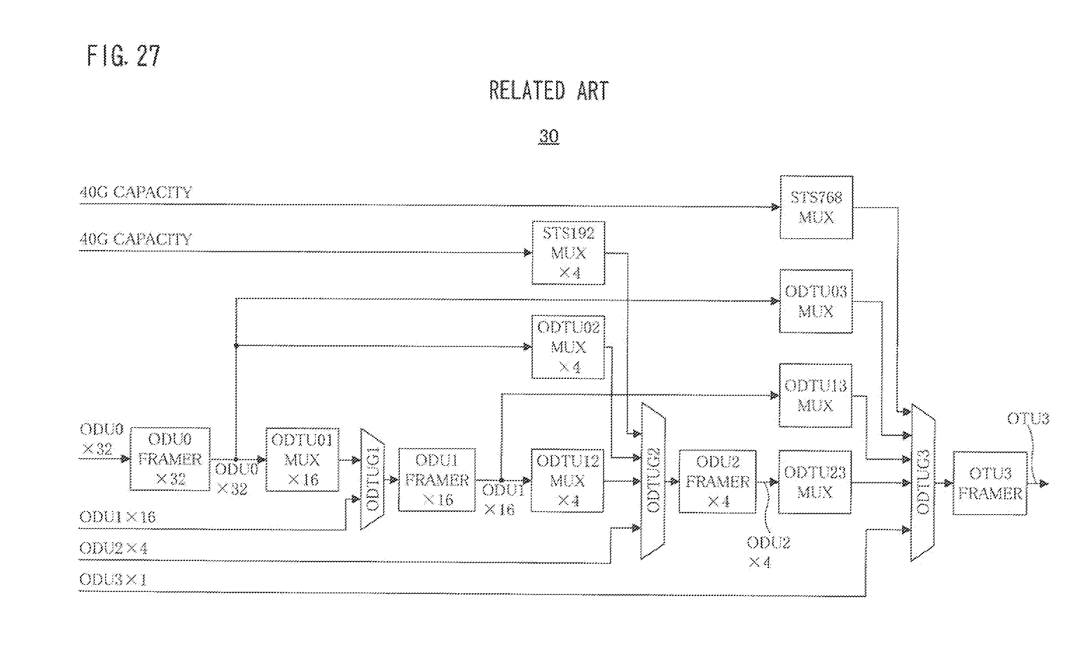

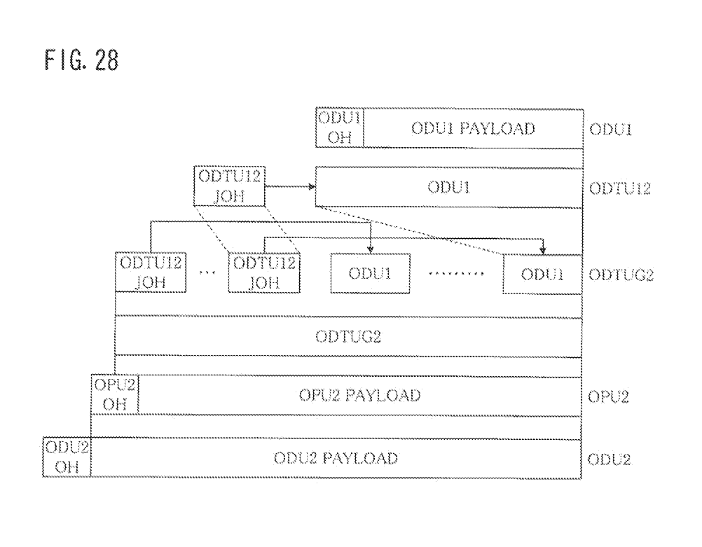

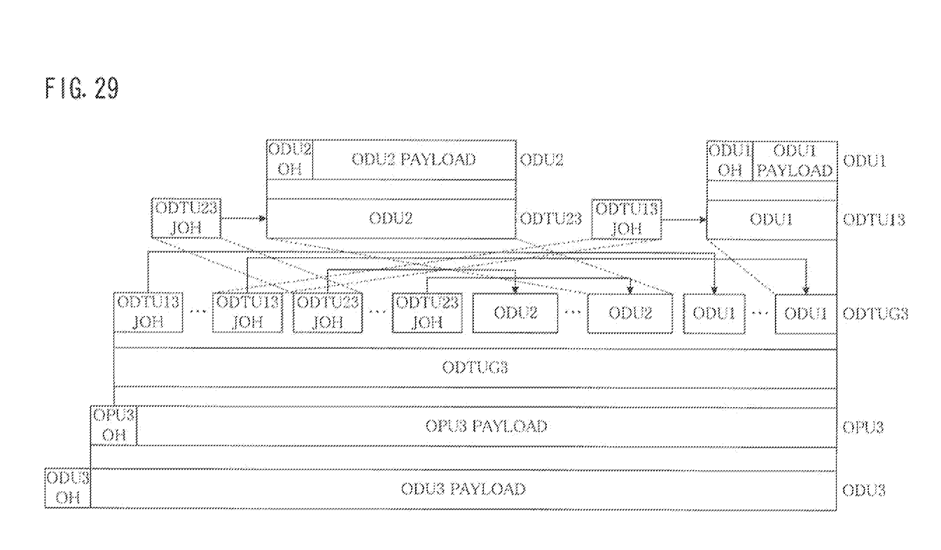

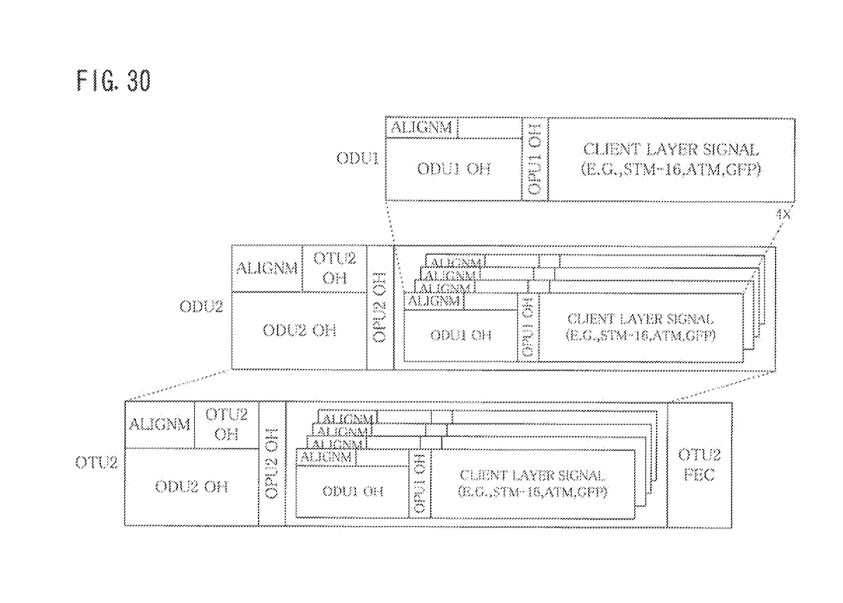

Stated differently, the demultiplexer 100 is not provided with any of general circuits illustrated in FIG. 26, i.e., a circuit for demultiplexing ODU0 from the individual levels of ODU3-ODU1, a circuit for demultiplexing the ODU1 from the ODU3 and the ODU2, and a circuit for demultiplexing the ODU2 from the ODU3.

The following is a description of the TS.

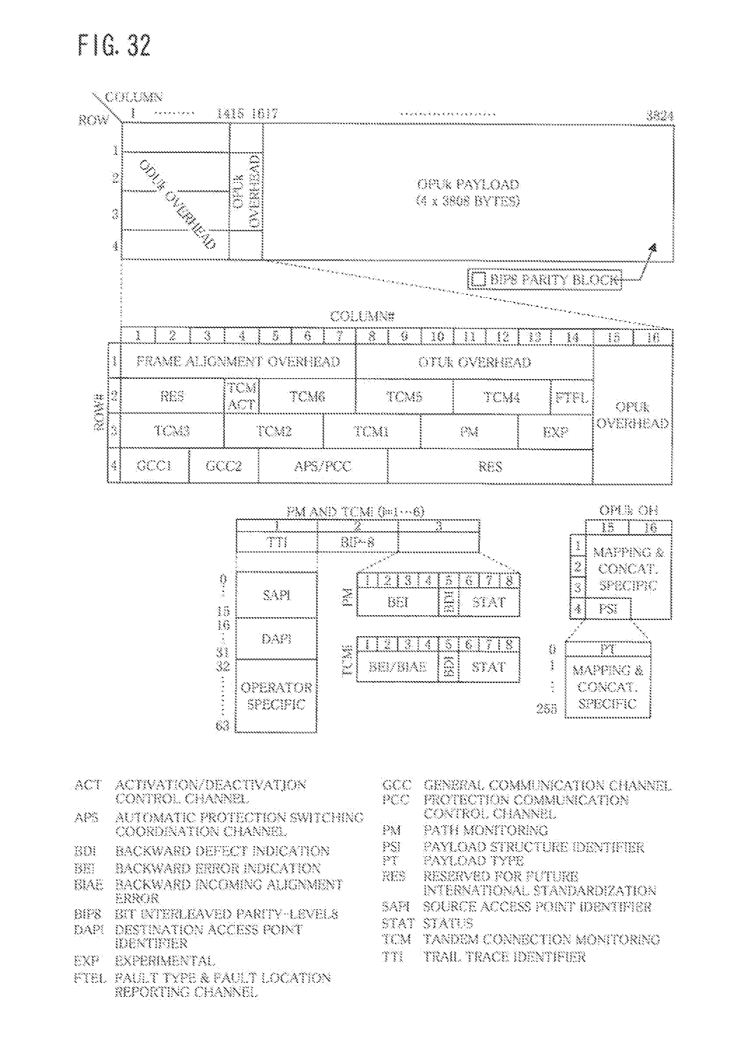

Optical channel Payload Unit (OPU) (see FIG. 32) is configured of a plurality of TS's and they are arranged alternately.

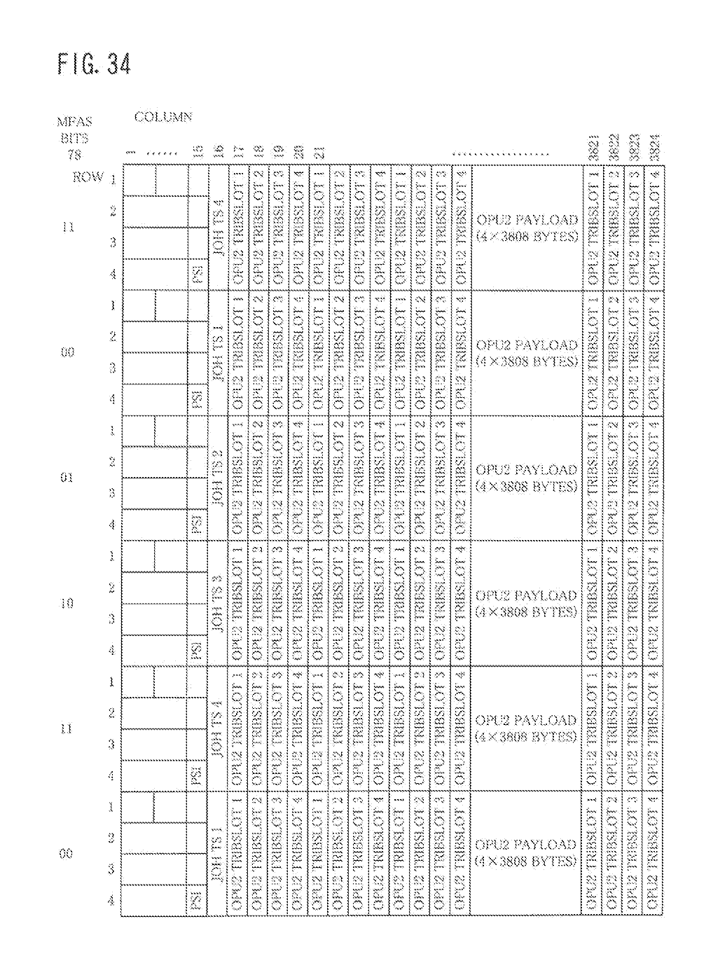

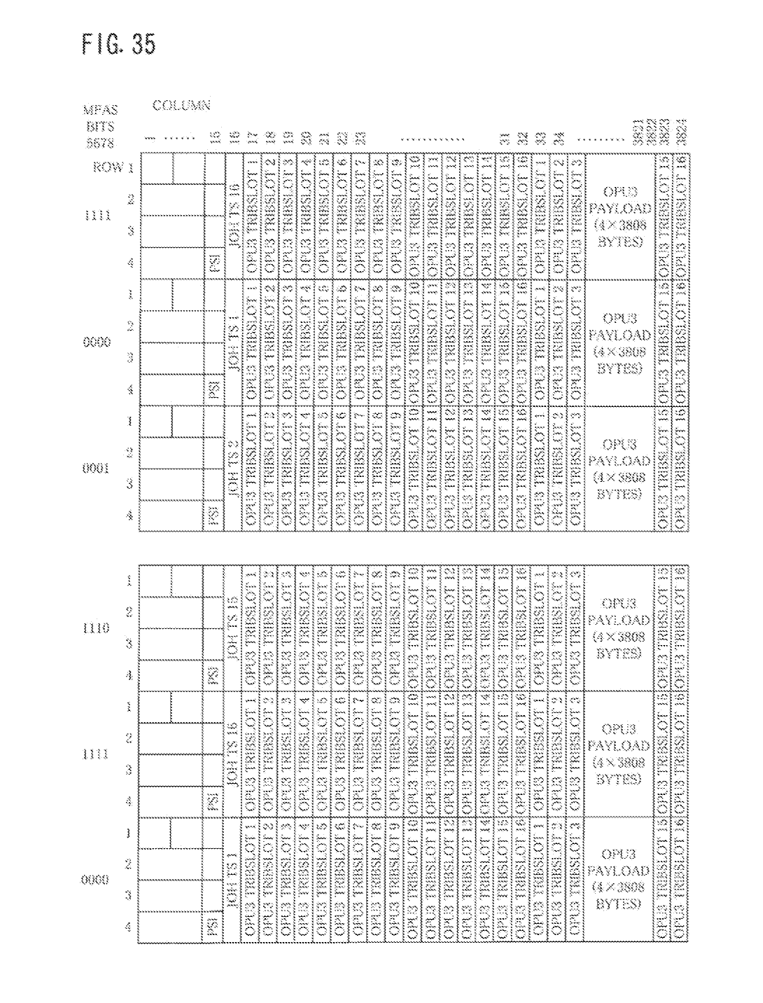

FIG. 34 is a diagram illustrating how to allocate TS's in OPU2. The ODU1 is mapped into one TS. FIG. 35 is a diagram illustrating how to allocate TS's in OPU3. The ODU1 is mapped into one piece of TS, and the ODU2 is mapped into four TS's.

The demultiplexer 100 of the first embodiment is configured to extract TS's from a signal fed thereinto, sort the extracted TS's if necessary, and generate any signals for ODU0-ODU3 from the sorted TS's if necessary. The TS's are extracted in structural units of ODU corresponding to the smallest unit of ODU levels that are processable by the demultiplexer 100.

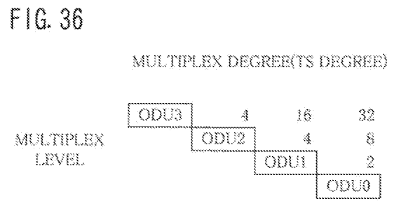

Suppose that, for example, the demultiplexer 100 is capable of dealing with ODU levels (types) of ODU0-ODU3, and receives an input of an ODU3 signal. In such a case, since the ODU3 is capable of containing 32 pieces of ODU0 (see FIG. 36), the demultiplexer 100 extracts 32-slot TS signals from the input ODU3 signal. Alternatively, suppose that, for example, the demultiplexer 100 is capable of dealing with ODU levels of ODU1-ODU3, and receives an input of an ODU3 signal. In such a case, since the ODU3 is capable of containing 16 pieces of ODU1, the demultiplexer 100 extracts 16-slot TS signals from the input ODU3 signal.

As discusses above, the demultiplexer 100 performs a demultiplexing process on the basis of TS irrespective of ODU levels of ODU signals fed thereinto, so that the process steps are simplified and the functions are easily expanded.

Generating signals at the individual ODU levels from the TS's eliminates the need for demultiplexing circuits for the individual ODU levels. Even if a new ODU level is standardized, a prompt response is possible by adding a Framer for the new ODU, or the like.

Stated differently, the scale of a circuit is increased because a necessary capacity of a memory is increased, the process steps are complicated, wiring resources involved therewith are increased, and so on. This leads to the possibility that there is no device realizing the apparatus. Even if the problem of the circuit scale is solved, another problem of heat may arise from the increase of the power consumption. Further, another problem may arise in which the development period is increased and the products cannot be released to the market timely. These problems may not occur in the demultiplexer 100.

The following is a description of a demultiplexer which receives an input of OTU3 and outputs a 40 G (Giga byte) signal. It is assumed that the demultiplexer 100 deals with ODU levels of ODU0-ODU3.

[Configuration]

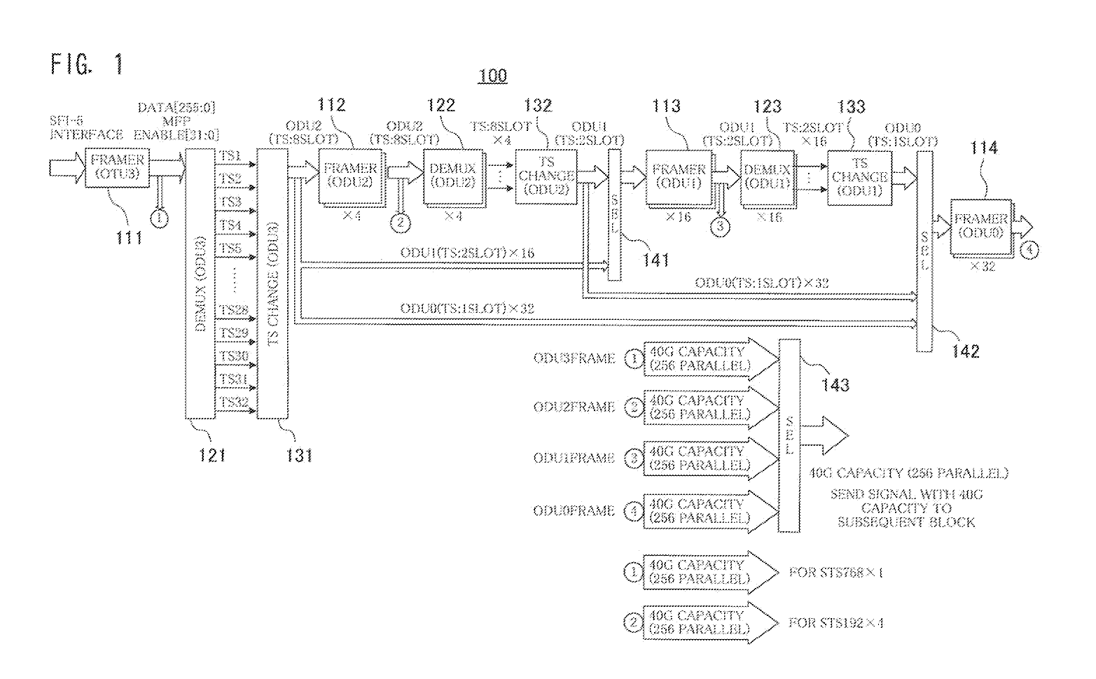

FIG. 1 is a diagram illustrating an example of the functional configuration of the demultiplexer 100.

The demultiplexer 100 is configured of Framers, Demux modules, TS-change modules, and SEL modules. These modules perform communication with a CPU through a register if necessary.

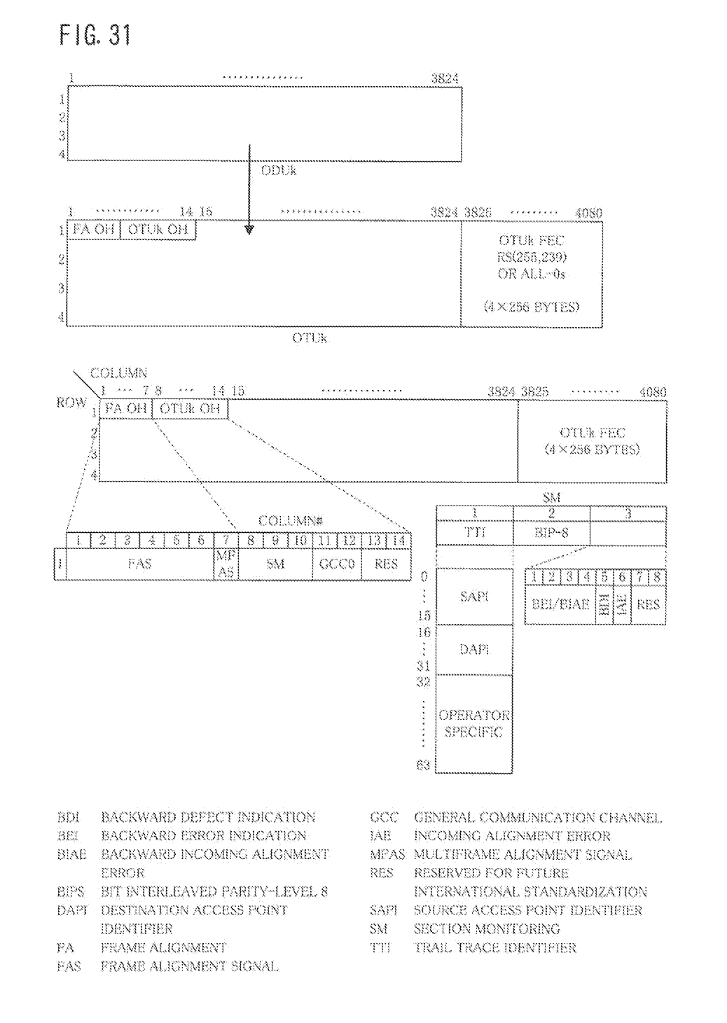

The Framers are one OTU3-Framer 111, 4 ODU2-Framers 112, 16 ODU1-Framers 113, and 32 ODU0-Framers 114. Note that OTU is data obtained by adding Forward Error Correction (FEC) to ODU, and describing information on the OTU in a part of OverHead (hereinafter, referred to as “OH”) of the ODU (see FIG. 31).

The Demux modules are one ODU3-Demux module 121, 4 ODU2-Demux modules 122, and 16 ODU1-Demux modules 123.

The TS-change modules are one ODU3-TS-change module 131, one ODU2-TS-change module 132, and one ODU1-TS-change module 133.

The SEL modules are a SEL module 141, a SEL module 142, and a SEL module 143.

The OTU3-Framer 111 creates an ODU3-frame signal according to an ODU3-frame configuration.

The ODU3-Demux module 121 extracts TS signals of TS1 through TS32 from the ODU3-frame signal created by the OTU3-Framer 111.

The ODU3-TS-change module 131 sorts the 32-slot TS signals extracted by the ODU3-Demux module 121 and outputs the resultant.

The reason for the sort of the TS's by the ODU3-TS-change module 131 is that the processes in a subsequent stage are easily performed in units of ODU levels. To be specific, the TS signals fed out from the ODU3-TS-change module 131 are fed into the 4 ODU2-Framers 112 of a subsequent stage by 8 slots. For this reason, the sort is so performed that the TS signals to be processed by the individual ODU2-Framers 112 are fed thereinto correctly. The same is similarly applied to the ODU2-TS-change module 132 and the ODU1-TS-change module 133.

Each of the ODU2-Framers 112 receives the input of the predetermined 8-slot TS signals from the ODU3-TS-change module 131, and creates an ODU2-frame signal. The ODU2-frame signal is the ODU2 that has been mapped into the ODU3. Accordingly, in the case where two pieces of ODU2 are mapped into ODU3, 2 of the 4 ODU2-Framers 112 are operated and the other 2 ODU2-Framers 112 are not operated. This makes it possible to save the power. Likewise, other Framers discussed below are not operated when the operation thereof is unnecessary, so that the power consumption is saved.

Each of the ODU2-Demux modules 122 extracts 8-slot TS signals from an ODU2-frame signal created by the corresponding ODU2-Framer 112. In the case where the corresponding ODU2-Framer 112 does not operate, the ODU2-Demux module 122 does not operate, either. The same is similarly applied to other Demux modules described later.

The ODU2-TS-change module 132 sorts a total of 32-slot TS signals outputted from the 4 ODU2-Demux modules 122 and outputs the resultant. In the case where, for example, two pieces of ODU2 are mapped into ODU3, the ODU2-TS-change module 132 sorts 16-slot TS signals outputted from 2 of the ODU2-Framers 112. The same is similarly applied to other TS-change modules described later.

Each of the ODU1-Framers 113 receives an input of 2-slot TS signals, and creates an ODU1-frame signal. Each of the ODU1-Framers 113 receives an input of 2-slot TS signals selected by the SEL module 141 among the TS signals outputted from the ODU2-TS-change module 132 and the TS signals outputted from the ODU3-TS-change module 131. How a SEL module selects TS signals is described later in [SEL module] section.

Each of the ODU1-Demux modules 123 extracts 2-slot TS signals from an ODU1-frame signal created by the corresponding ODU1-Framer 113.

The ODU1-TS-change module 133 sorts a total of 32-slot TS signals outputted from the 16 ODU1-Demux modules 123 and outputs the resultant.

Each of the ODU0-Framers 114 receives an input of 1-slot TS signal, and creates an ODU0-frame signal. Each of the ODU0-Framers 114 receives an input of 1-slot TS signal selected by the SEL module 142 among the TS signals outputted from the ODU1-TS-change module 133, the TS signals outputted from the ODU3-TS-change module 131, and the TS signals outputted from the ODU2-TS-change module 132.

Lastly, the SEL module 143 selects a signal from among the ODU3-frame signal (see encircled number 1) created by the OTU3-Framer 111, the ODU2-frame signal (see encircled number 2) created by the ODU2-Framer 112, the ODU1-frame signal (see encircled number 3) created by the ODU1-Framer 113, and the ODU0-frame signal created by the ODU0-Framer 114. Thereby, a signal having a desired structure is generated.

Descriptions are provided below of a Demux module, a TS-change module, and a SEL module.

[Demux Module]

The ODU3-Demux module 121, the ODU2-Demux module 122, and the ODU1-Demux module 123, which are provided in the demultiplexer 100 as Demux modules, have the same configuration as each other. These Demux modules are collectively referred to as a Demux module 120.

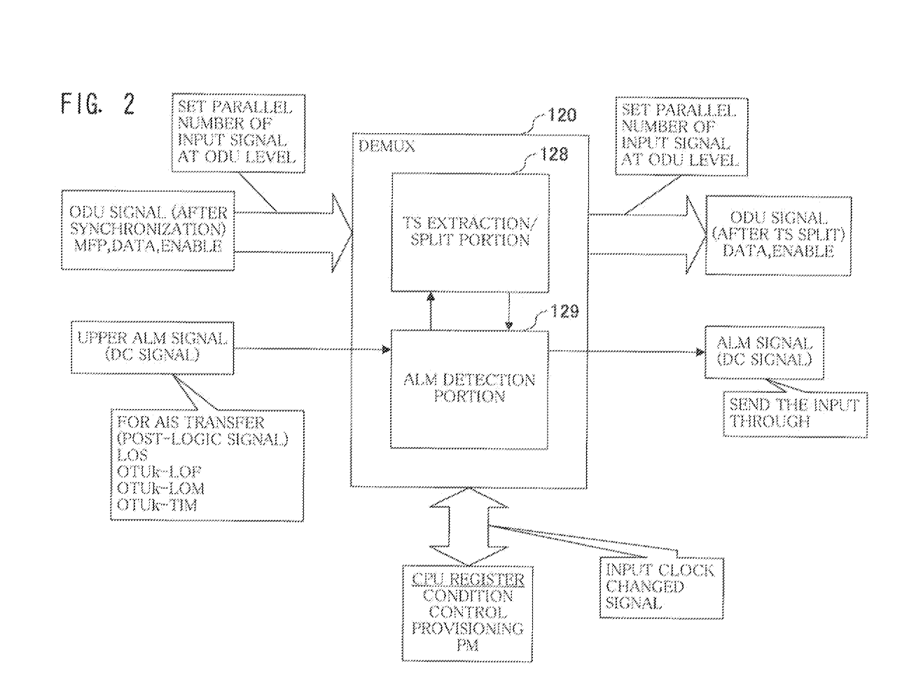

FIG. 2 is a diagram illustrating an example of the configuration of the Demux module 120.

The Demux module 120 is configured of a TS extraction/split portion 128 and an ALM detection portion 129.

The TS extraction/split portion 128 splits an input ODU signal and extracts a TS at the ODU0 level.

A general demultiplexer is provided with a demultiplexing circuit for extracting TS's at the individual levels, e.g., extracting ODU2 from ODU3, extracting ODU1 from ODU3, and extracting ODU0 from ODU3 (see FIG. 26). In contrast, the Demux module 120 as a demultiplexing circuit provided in the demultiplexer 100 extracts TS at the ODU0 level.

The ALM detection portion 129 determines whether an input signal is normal or not.

The Demux module 120 obtains, from the CPU, information necessary for the demultiplexing process through a CPU register block, or, alternatively, requests the CPU to perform operation.

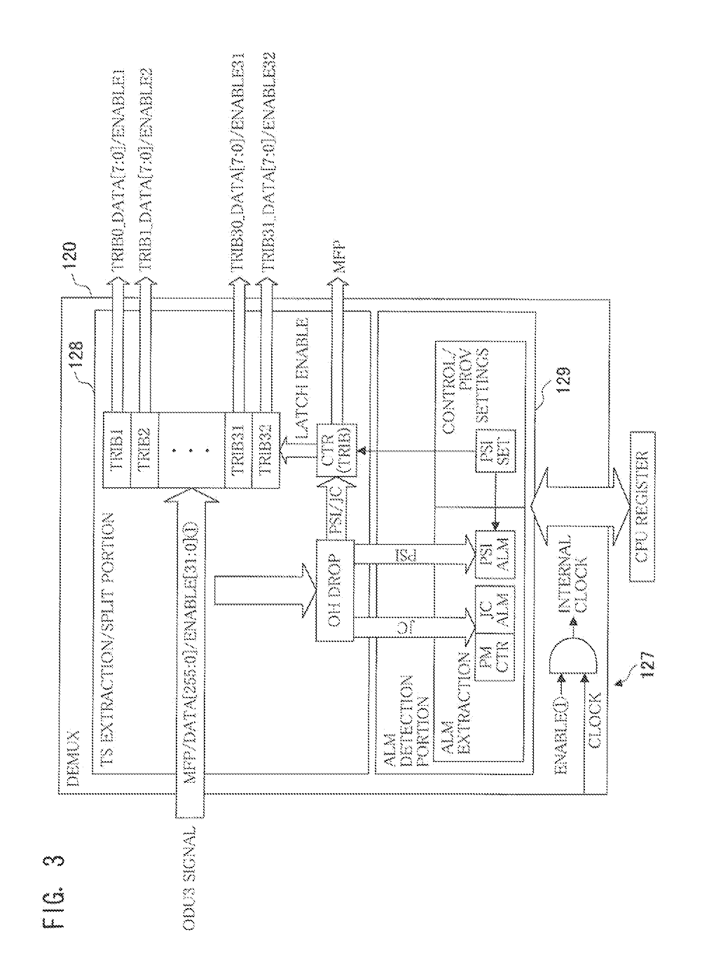

FIG. 3 is a diagram illustrating an example of the detailed configuration of the ODU3-Demux module 121.

An ODU3 signal is fed into the TS extraction/split portion 128. To be specific, an MFP (frame phase synchronization pulse), a data signal, and an enable signal are fed into the TS extraction/split portion 128.

The data signal is a parallel signal, and 256-bit data is simultaneously fed into the TS extraction/split portion 128. In the illustrated example, the data signal is denoted by DATA[255:0]. The enable signal is fed into the TS extraction/split portion 128 in units of bytes, and is denoted by Enable [31:0] in FIG. 3. Thus, it is indicated that Enable [31:0] reads 256-parallel signals of DATA [255:0] therein.

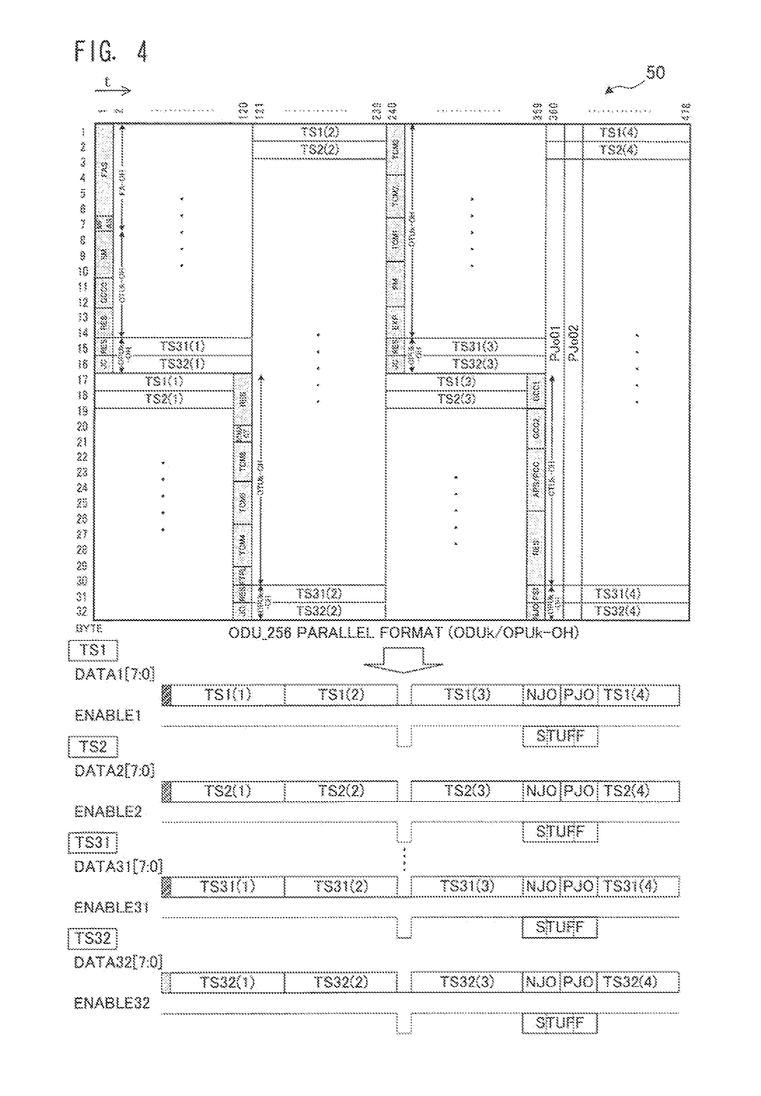

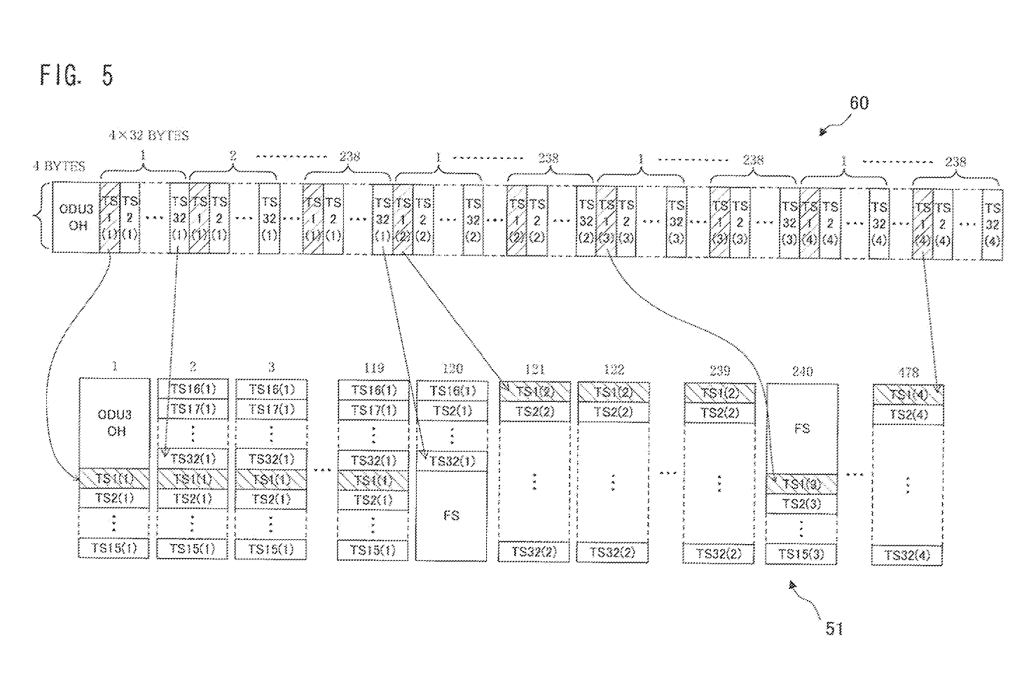

The data signal of the ODU3 is described with reference to FIGS. 4 and 5.

FIG. 4 is a diagram illustrating a data signal 50 fed into the ODU3-Demux module 121 and TS signals fed out therefrom. The data signal 50 is an ODU_256 parallel format signal. The diagram above the down-arrow illustrates the data signal 50, while the diagram therebelow illustrates the TS signals fed out from the ODU3-Demux module 121.

FIG. 5 is a diagram illustrating how ODU3 data (see FIG. 35) is arranged in the data signal 50 of FIG. 4. A data signal 51 of FIG. 5 is a more detailed version of a data signal 60 of FIG. 5. The total 478 columns of the data signal 51 of FIG. 5 are illustrated with 120 columns thereof as a group as illustrated in FIG. 4.

Each piece of 32-byte data from the front of the ODU3 data 60 illustrated in the upper diagram of FIG. 5 is inputted as a 256-parallel signal of the data signal 51 illustrated in the lower diagram. The OverHead (OH) of the ODU3 is 16 bytes in size.

With respect to TS1, for example, the 1^{st} column to the 119^{th} column of the data signal 51 is inputted as the 17^{th} row byte signal (see the hatched TS1(1) of FIGS. 4 and 5). The 120^{th} column to the 239^{th} column of the data signal 51 is inputted as the 1^{st} row byte signal (see the hatched TS1(2) of FIGS. 4 and 5). The 240^{th} column to the 359^{th} column of the data signal 51 is inputted as the 17^{th} row byte signal (see the hatched TS1 (3) of FIGS. 4 and 5). The 360^{th} column to the 478^{th} column of the data signal 51 is inputted as the 1^{st} row byte signal (see the hatched TS1(4) of FIGS. 4 and 5).

The resultant of the sequential extraction of TS1(1) through TS1(4) is outputted as an 8-bit parallel signal of the TS1 illustrated in the lower part of FIG. 4.

Signals from TS2 through TS32 are outputted in a manner similar to the manner described above. The OH portion of an enable signal is set to “L” (disable), and a stuff byte process is set to “L” (disable) on the basis of information detected by JC byte for additional disabling.

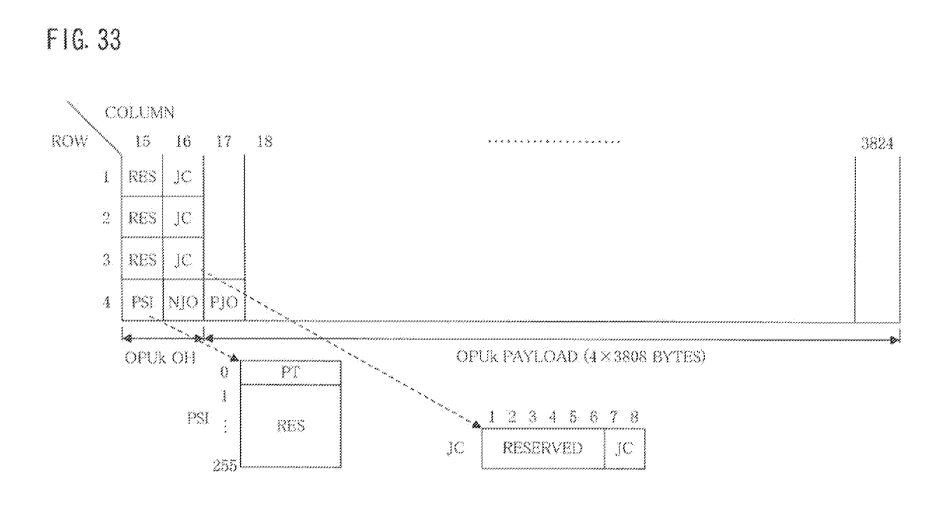

When an ODU3 signal is fed into the Demux module 120, an OH-drop portion detects the OH of the ODU3 on the basis of MFP/Data/Enable of the ODU3 signal thus fed into. The OH-drop portion extracts stuff information (JC byte) (see FIG. 33) and multi-frame information (PSI byte) (see FIG. 32) of the detected OH.

The OH-drop portion operates a frame CTR (TRIB) based on the extracted stuff information and multi-frame information, and generates latch enable.

The OH-drop portion sends the extracted stuff information and multi-frame information to the ALM detection portion in addition to the generation of the latch enable. This is because the ALM detection portion checks whether or not the input information is appropriate (normal).

The ALM detection portion detects the stuff information and multi-frame information received from the OH-drop portion, i.e., ALM of JC byte and PSI byte.

The ALM detection for PSI is performed in the following manner. An ALM extraction block receives a preset value (expected value) of PSI through a control/prov settings block, and the ALM detection is performed based on whether or not the received expected value matches the PSI fed from the OH-drop portion (condition notice). The control/prov settings block receives the expected value of the PSI from the CPU register block connected thereto.

The ALM detection for JC is performed in the following manner. The ALM extraction block detects an error of the stuff information by making a determination based on a majority of the stuff information. A result of the accumulated value of justification (PJ, NJ) is conveyed as a PM notice.

The CPU register block sets the parallel number of data signals depending on the ODU level. For example, the CPU register block sets, as the parallel number, 256, 64, 16, and 8 for inputs of ODU3, ODU2, ODU1, and ODU0, respectively.

The TS extraction/split portion 128 uses information of the latch enable generated by the frame CTR (TRIB) to allocate the data signal to 32 registers, i.e., TRIB0-TRIB31, so that the signal is split in units of ODU0 (see the lower diagram of FIG. 4).

The resultant data obtained by the split is fed out to TRIBn_Data [7:0] (n=0−31) with respect to an FP (frame timing) from the CTR portion. For example, TRIB0_Data [7:0] corresponds to TS1 of FIG. 4.

A circuit 127 provided in the lower left of the ALM detection portion 129 is a circuit having a function to mask an input clock with an input enable signal.

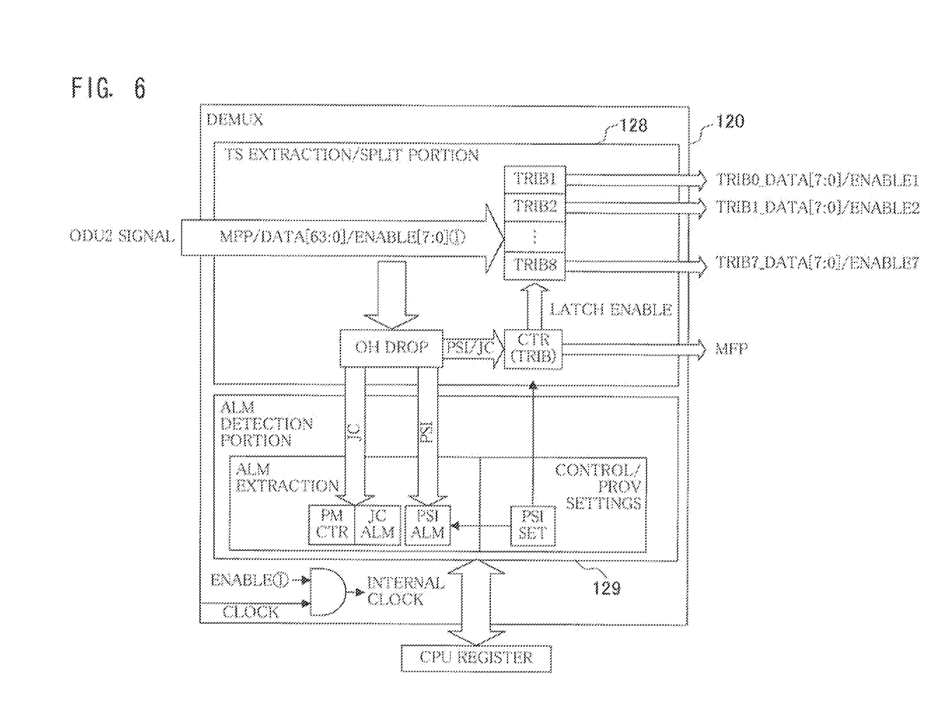

FIG. 6 is a diagram illustrating an example of the configuration of the ODU2-Demux module 122. Since the ODU2 is configured of 8 TS's, the data signal is a 64-parallel signal. In other words, the data signal is a signal to be processed in units of 64 bits. The ODU2-Demux module 122 feeds out TRIB0_Data0 through TRIB7_Data.

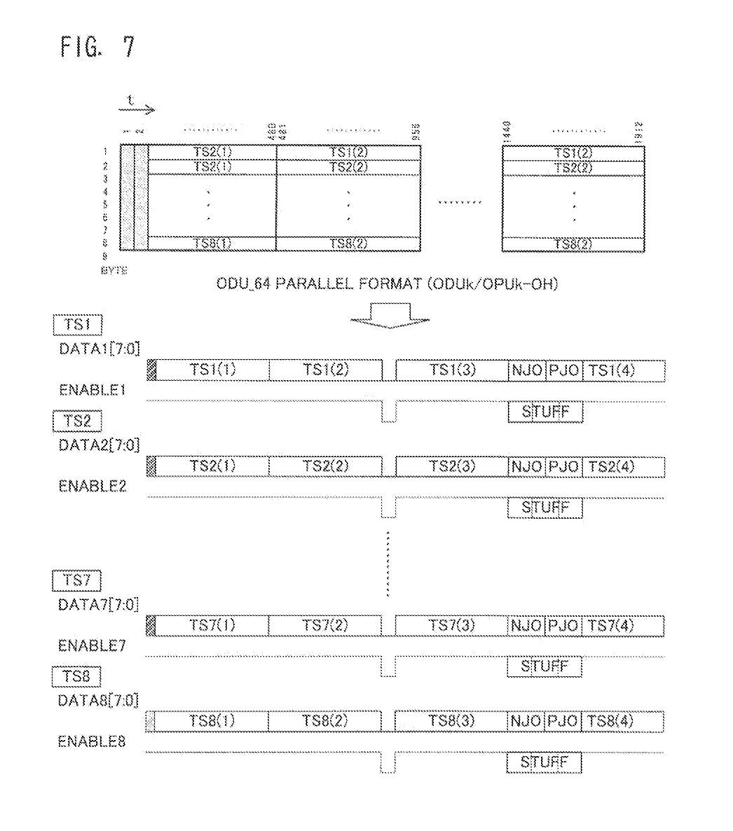

FIG. 7 is a diagram illustrating a data signal fed into the ODU2-Demux module 122 and TS signals fed out therefrom. The data signal is an ODU_{—}64 parallel format signal. The diagram above the down-arrow illustrates the data signal, while the diagram therebelow illustrates the TS signals fed out from the ODU2-Demux module 122.

The parallel degree of ODU0, which is the smallest ODU level, is 8-parallel. Accordingly, after extraction of TS's, processes performed by Framers can be facilitated. In addition, there is no need for the individual Demux modules to have memories. Since it is possible to determine data constituting ODU in 8-parallel, i.e., in units of bytes, an unnecessary circuit through which no data flow can be stopped, which results in saving the power consumption.

[TS-Change Module]

The ODU3-TS-change module 131, the ODU2-TS-change module 132, and the ODU1-TS-change module 133, which are provided in the demultiplexer 100 as TS-change modules, have the same configuration as each other. These TS-change modules are collectively referred to as a TS-change module 130.

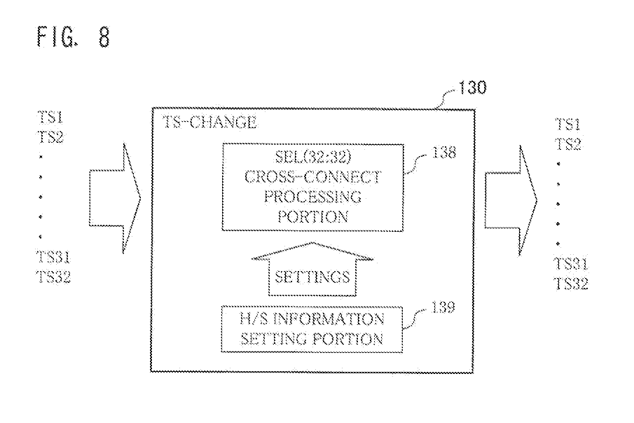

FIG. 8 is a diagram illustrating an example of the configuration of the TS-change module 130.

The TS-change module 130 receives inputs of 32-slot TS signals denoted by TS1-TS32, performs sorting, and outputs the sorted 32-slot TS signals denoted by TS1-TS32. The reference symbols “TS1”-“TS32” denote numbers of the input/output signals, and are independent of the details of the signals. For example, if a signal that has been inputted as TS1 is sorted and fed out from TS5, then the signal is deemed as a TS5 signal.

The TS-change module 130 is configured of a cross-connect processing portion 138 and an H/S information setting portion 139.

The cross-connect processing portion 138 is configured of a matrix switch circuit in units of ODU0, and capable of changing the output port of each of TS1-TS32 to be inputted.

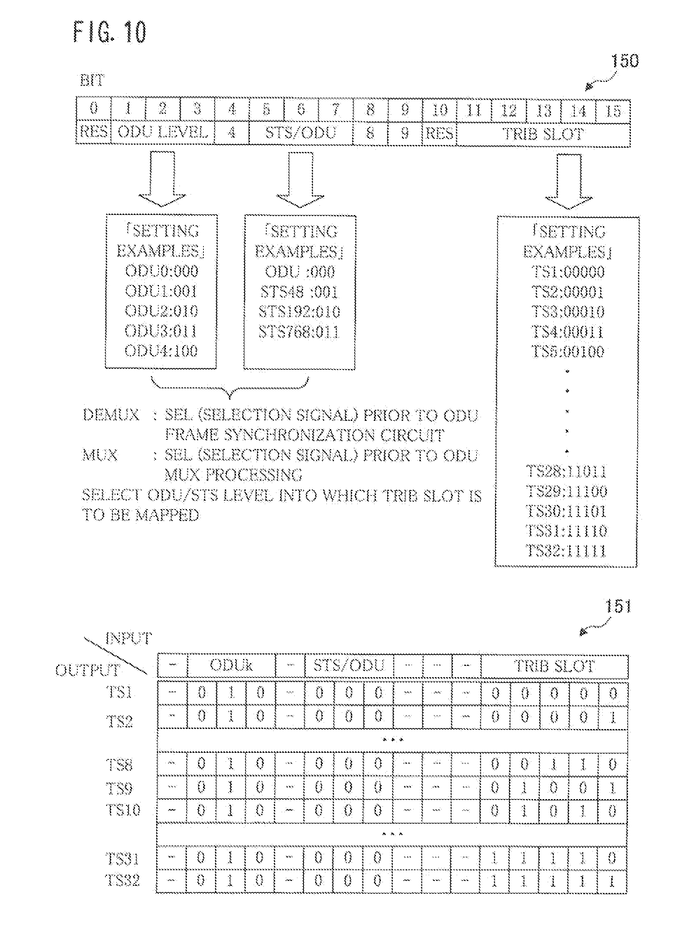

The H/S information is to specify how TS's to be inputted are sorted and outputted. The H/S information will be described later in [H/S information] section with reference to FIG. 10.

The H/S information setting portion 139 obtains preset H/S information through the CPU register, and sets selection signals for sorting TS's based on the obtained H/S information.

The H/S information setting portion 139 also performs illegality determination process on the set H/S information. When determining that the set H/S information is illegal, the H/S information setting portion 139 prevents unintended data from flowing through the transmission line. Such prevention makes it possible to secure the quality of the line.

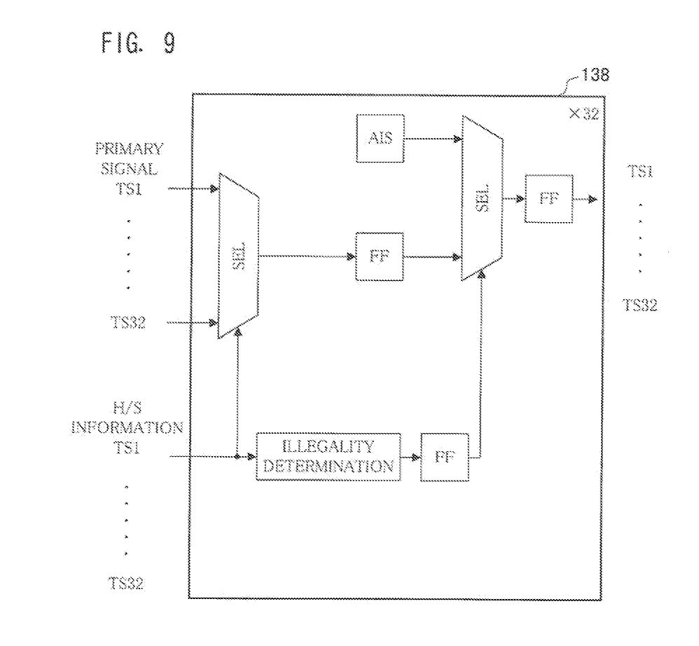

FIG. 9 is a diagram illustrating an example of the detailed configuration of the cross-connect processing portion 138.

The cross-connect processing portion 138 is configured to include 32 sets of the circuit illustrated in FIG. 9.

The circuit of FIG. 9 is configured in such a manner that a SEL module of a preceding stage selects one of TS1-TS32, and a SEL module of a subsequent stage performs a process for illegal setting.

The line path is determined by allocating primary signals TS1-TS32 extracted in the Demux module processing block such as the ODU3-Demux module 121 to the registers corresponding to TS1-TS32 specified in the H/S information.

The illegality determination block refers to an H/S information register provided in the H/S information setting portion 139 (see Sig. 8), and detects whether or not the H/S information has been set erroneously. In the case where the illegality determination block detects an erroneous setting, information in which the line is unset is outputted in a SEL module of a subsequent stage.

[H/S Information]

FIG. 10 is a diagram illustrating an example of the structure and the details of H/S information.

The upper diagram of FIG. 10 illustrates an example of the structure of H/S information 150, and the lower diagram thereof illustrates a settings example 151 of H/S information.

The H/S information is set in TS-change modules and SEL modules.

The H/S information 150 is, for example, 16-bit data, and is set in the TS-change module 130 by quantity corresponding to the number of TS's. The H/S information 150 corresponds to each TS to be outputted, and specifies an input TS number.

The ODU levels of ODU0-ODU4 are set in “ODU level” of the H/S information 150, and the type, i.e., ODU or STS, and an STS level are set in “STS/ODU” of the H/S information 150. The settings details in “ODU level” and “STS/ODU” designate from which one of ODU and STS the TS is to be inputted. The designation is effective in the case of selection by a SEL module described later.

The TS number on the input side is set in “Trib Slot” of the H/S information 150.

The settings example 151 is configured of 32 pieces of H/S information 150 based on which outputs to TS's denoted by “Trib Slot1” to “Trib Slot32” are commanded.

For example, an ODU1 signal inputted from “TS7” is outputted as an output signal from “TS8”.

Further, it is assumed that line unset information is settable in the H/S information.

[SEL Module]

As with the case of the TS-change module 130, the SEL module 141, the SEL module 142, and the SEL module 143 that are provided, as SEL modules, in the demultiplexer 100 serve to set which TS signal is selected based on the H/S information.

For example, the SEL module 141 selects predetermined 32-slot TS signals from among 32-slot TS signals fed out from the ODU2-TS-change module 132 and 32-slot TS signals fed out from the ODU3-TS-change module 131. The 32-slot TS signals thus selected are fed into the 16 ODU1-Framers 113.

The settings details in “ODU level” and “STS/ODU” specify from which one of the ODU2-TS-change module 132 and the ODU3-TS-change module 131 a TS signal is inputted. The SEL module does not sort the TS signals. Thus, the same number as that in the TS number on the output side is set in “Trib Slot”.

The detailed configuration of the SEL module is similar to the circuit described earlier with reference to FIG. 9. Although 32 sets of the circuit are provided in the TS-change module, the number of circuits provided in the SEL module corresponds to the number of TS's fed into the SEL module. TS's to be output are TS1-TS32.

[Operation]

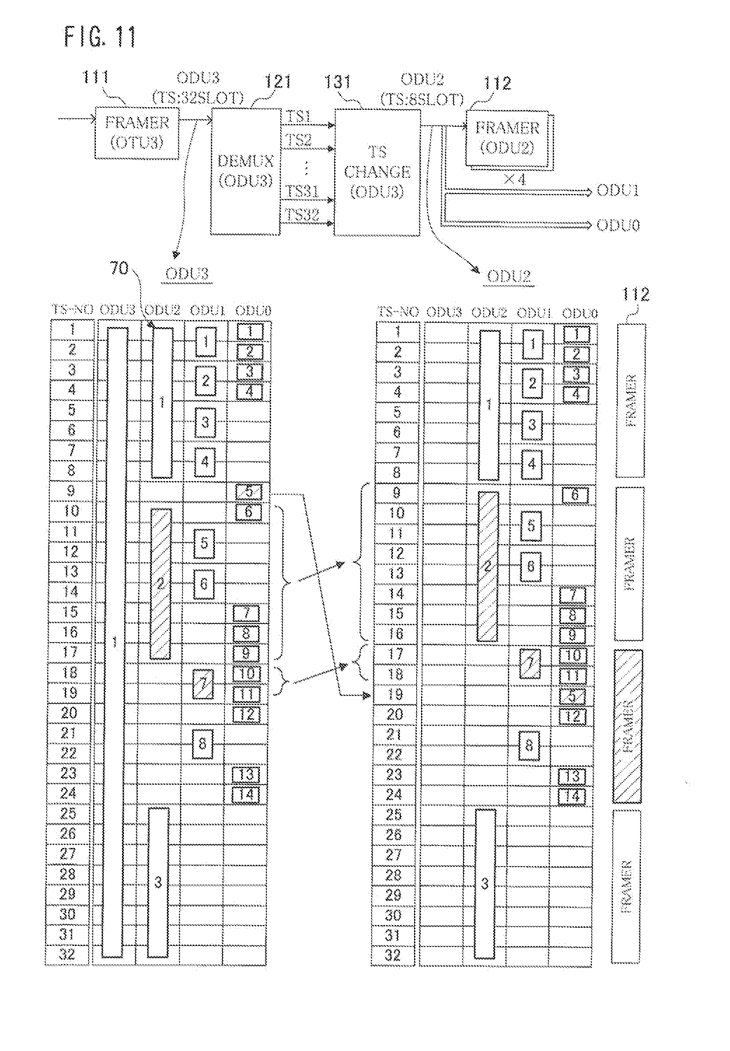

The following is a description of the operation of the demultiplexer 100 according to this embodiment with reference to FIGS. 11-16.

FIGS. 11-15 are diagrams illustrating data flow in a demultiplexing process.

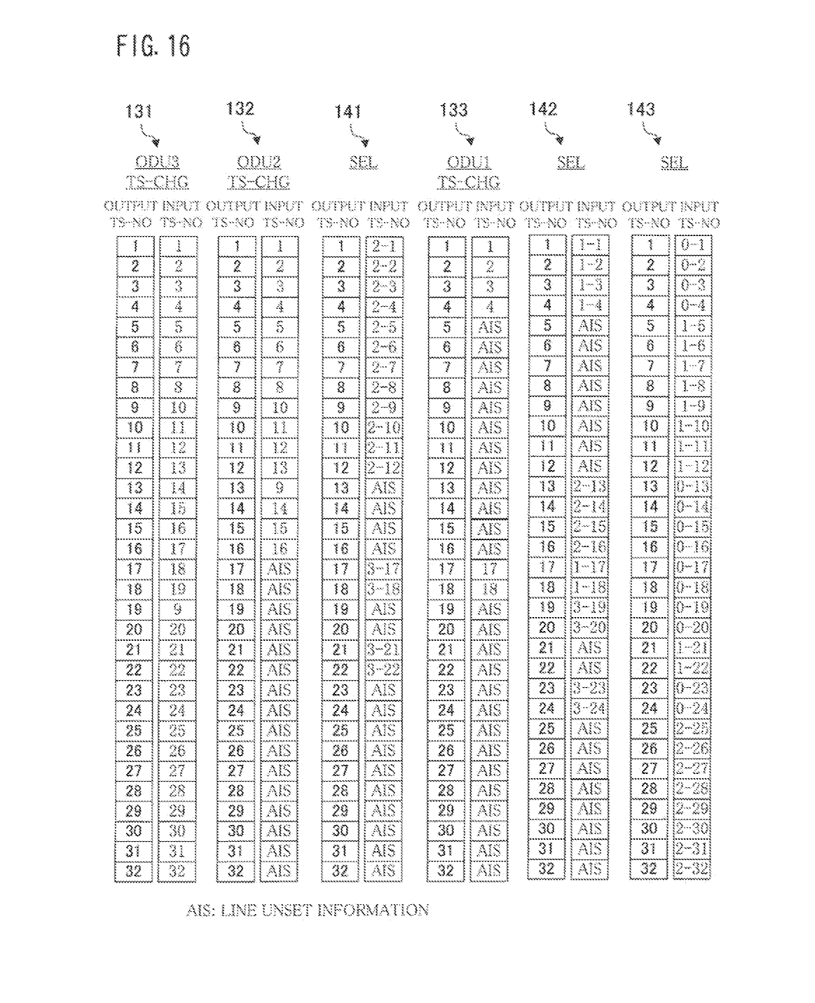

FIG. 16 illustrates the details of H/S information set in TS-change modules and SEL modules.

FIG. 11 illustrates ODU3 that is an input signal to the ODU3-Demux module 121, and an output signal from the ODU3-TS-change module 131.

A rectangle shown in the field of ODU3 and the like indicates the TS numbers constituting the subject ODU, and the number in the rectangle indicate the identification number of the subject ODU. For example, a rectangle 70 of the field of ODU2 having the identification number “1” indicates that the rectangle 70 is constituted by eight TS's having TS numbers (TS-No.) 1 through 8.

The ODU3 signal fed out from the OTU3-Framer 111 contains, therein, 3 pieces of ODU2 (1, 2, and 3), 2 pieces of ODU1 (7 and 8), and 4 pieces of ODU0 (5, 12, 13, and 14). The numerals in the parentheses represent identification numbers of the individual pieces of ODU.

For example, ODU2(1) contains 4 pieces of ODU1 (1, 2, 3, and 4) therein, and ODU1(1) contains 2 pieces of ODU0 (1 and 2) therein.

The ODU3-Demux module 121 receives an input of the ODU3 signal from the OTU3-Framer 111, and feeds out 32-slot of TS1-TS32.

The ODU3-TS-change module 131 performs sorting to achieve frame synchronization of the 3 pieces of ODU2 (1, 2, and 3) for the ODU2-Framer 112.

To be specific, input signals TS10-TS17 are outputted as output signals TS9-TS16. Further, input signals TS18 and TS19 are outputted as output signals TS17 and TS18 for alignment of inputs to the ODU1-Framers 113 of a subsequent stage. Moreover, an input signal TS9 is outputted as an output signal TS19 (see the hatched rectangles representing ODU and the arrows of FIG. 11). The other input signals are outputted as output signals having the same numbers as those of the input signals (see the H/S information setting details 131 of FIG. 16).

At this time, out of the 4 ODU2-Framers 112, the ODU2-Framer 112 to which TS17-TS24 are to be inputted does not receive any inputs of TS's, and does not operate (see the hatched Framer of FIG. 11).

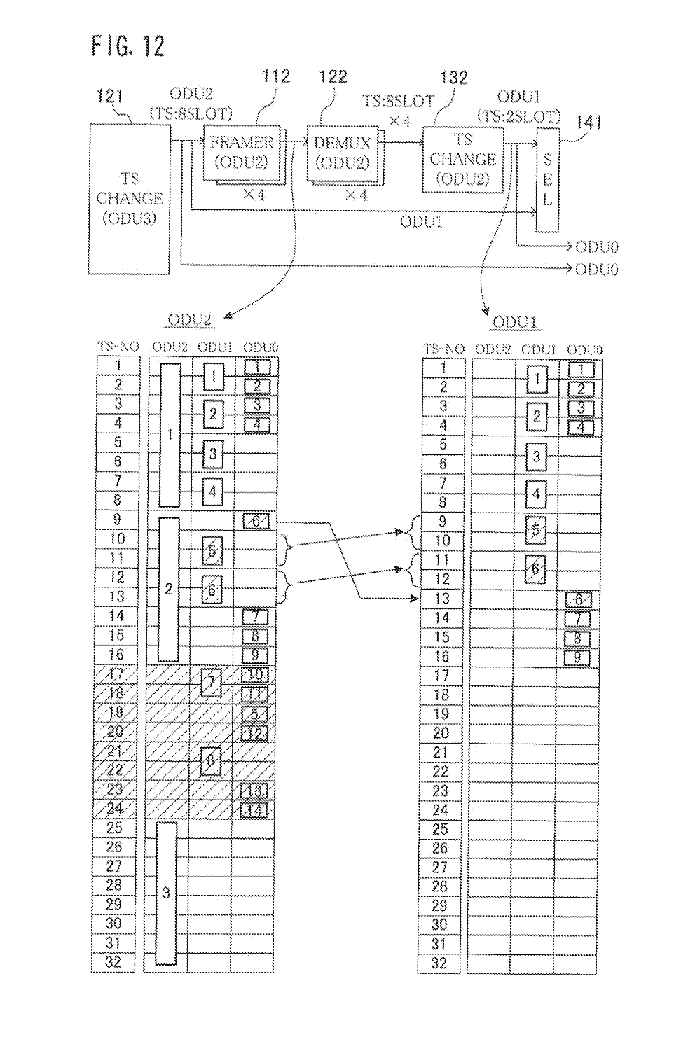

FIG. 12 illustrates ODU2 that is an input signal to the ODU2-Demux modules 122, and an output signal from the ODU2-TS-change module 132. The hatched part corresponding to TS17-TS24 of the ODU2 signal means that no signals are input. This signal corresponds to the output signal of unoperated ODU2-Framers 112.

The ODU2-TS-change module 132 outputs an input signal TS9 as an output signal TS13 for alignment of inputs to the ODU1-Framers 113 of a subsequent stage. Moreover, the ODU2-TS-change module 132 outputs input signals TS10 and TS11 as output signals TS9 and TS10, and outputs input signals TS12 and TS13 as output signals TS11 and TS12 (see the hatched rectangles representing ODU and the arrows of FIG. 12).

Input signals TS1-TS8, and input signals TS14-TS16 are outputted as output signals having the same numbers as those of the input signals.

Since the other output signals TS17-TS32 are not used any more in a subsequent stage, line unset information is outputted (see the H/S information setting details 132 of FIG. 16).

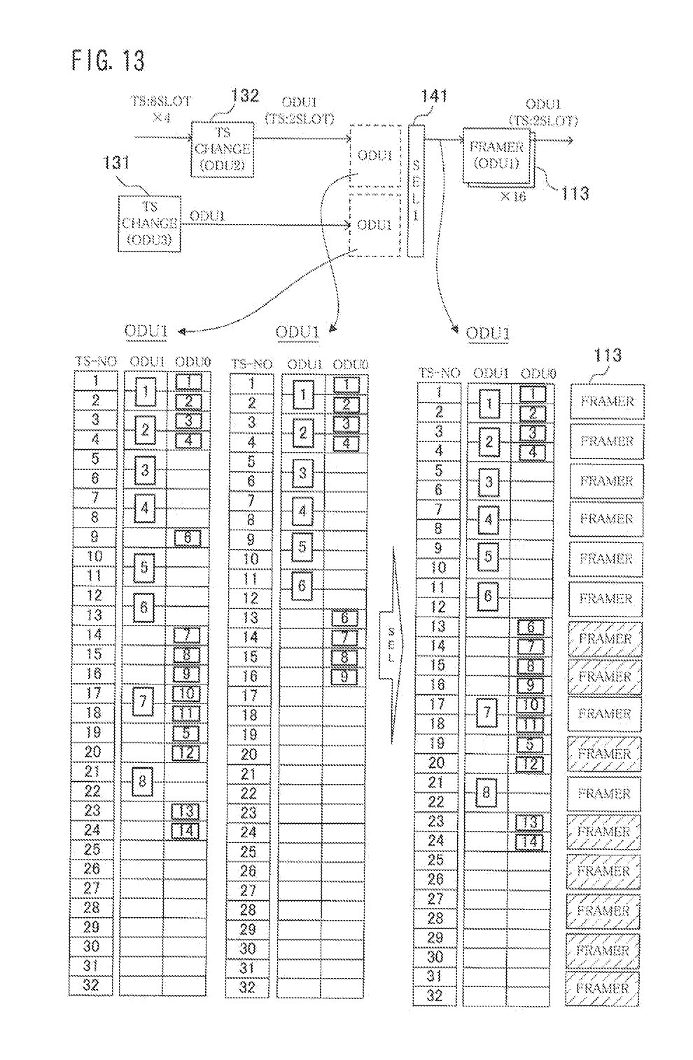

FIG. 13 illustrates an input signal ODU1 to the SEL module 141, and an output signal ODU1 therefrom.

The SEL module 141 selects TS's used for output to the ODU1-Framer 113 from among ODU1 outputted from the ODU2-TS-change module 132 and ODU1 outputted from the ODU3-TS-change module 131. This is because frame signals of ODU2 (1, 2, 3, 4, 5, 6, 7, and 8) are created.

To be specific, the SEL module 141 inputs signals TS1-TS12 from the ODU2-TS-change module 132, and outputs the signals TS1-TS12 as output signals TS1-TS12. Further, the SEL module 141 inputs signals TS17, TS18, TS21, and TS22 from the ODU3-TS-change module 131, and outputs the signals TS17, TS18, TS21, and TS22 as output signals TS17, TS18, TS21, and TS22.

Since the other output signals TS13-TS16, TS19, TS20, and TS23-TS32 are not used any more in a subsequent stage, line unset information is outputted (see the H/S information setting details 141 of FIG. 16).

Referring to the H/S information setting details 141 of FIG. 16, “2-1” indicated in “input TS-No.” represents TS1 from the ODU2-TS-change module 132. Likewise, “3-17” indicated therein represents TS17 from the ODU3-TS-change module 131.

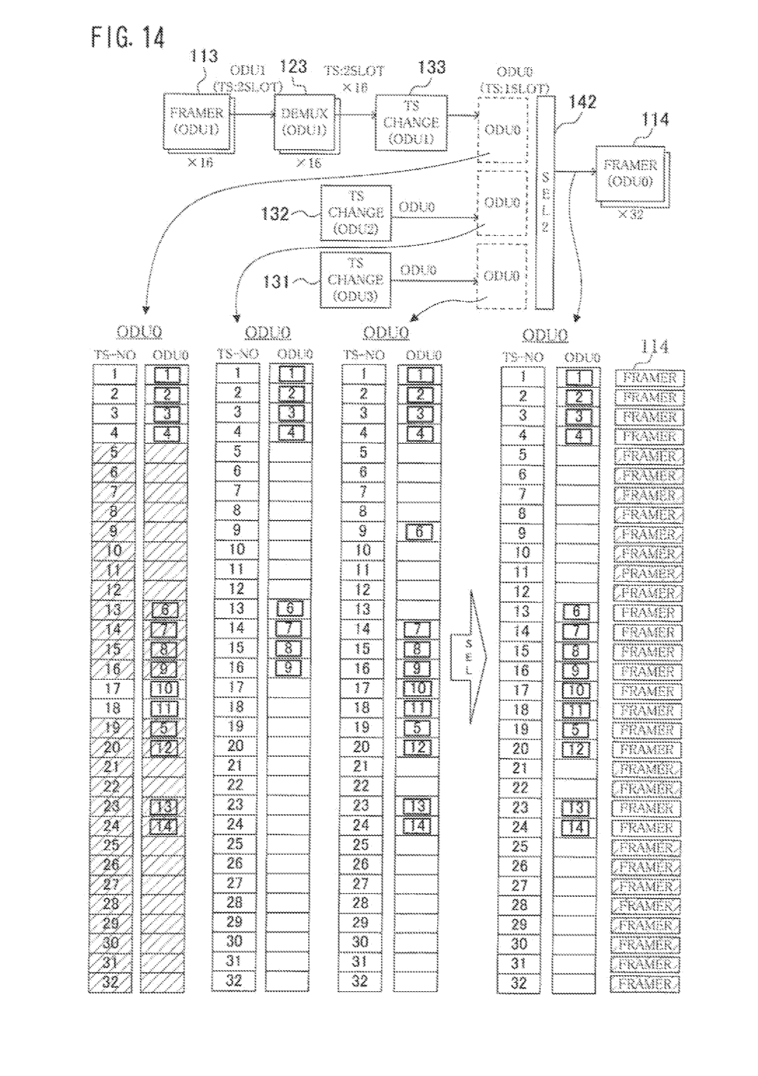

Out of the 16 ODU1-Framers 113, the ODU1-Framers 113 receiving an input of the line unset information do not operate (see the hatched Framers of FIG. 13, and the hatched parts of the ODU0 signal of FIG. 14).

FIG. 14 illustrates an input signal ODU0 fed into the SEL module 142, and an output signal ODU0 fed out therefrom.

The SEL module 142 selects TS's used for output to the ODU0-Framer 114 from among ODU0 outputted from the ODU1-TS-change module 133, ODU0 outputted from the ODU2-TS-change module 132, and ODU0 outputted from the ODU3-TS-Change module 131. The hatched parts of the ODU0 signal from the ODU1-TS-change module 133 mean that the signal is not fed in. The signal corresponds to the output signal from the ODU1-Framer 113 that does not operate as illustrated in FIG. 13.

The ODU1-TS-change module 133 feeds out input signals TS1-TS4 as output signals TS1-TS4, and feeds out input signals TS17 and TS18 as output signals TS17 and TS18.

Since the other output signals TS5-TS16, and TS19-TS32 are not used any more in a subsequent stage, line unset information is outputted (see the H/S information setting details 133 of FIG. 16, and the hatched ODUk of FIG. 14).

The SEL module 142 feeds, thereinto, TS1-TS4 from the ODU1-TS-change module 133, and feeds out the same as output signals TS1-TS4.

The SEL module 142 feeds, thereinto, TS13-TS16 from the ODU2-TS-change module 132, and feeds out the same as output signals TS13-TS16.

The SEL module 142 feeds, thereinto, TS17-TS20, TS23, and TS24 from the ODU3-TS-change module 131, and feeds out the same as output signals TS17-TS20, TS23, and TS24.

Since the other output signals TS5-TS12, TS21, TS22, and TS25-TS32 are not used any more in a subsequent stage, line unset information is outputted (see the H/S information setting details 142 of FIG. 16).

Out of the 32 ODU0-Framers 114, the ODU0-Framers 114 inputting the line unset information do not operate (see the hatched Framers of FIG. 14).

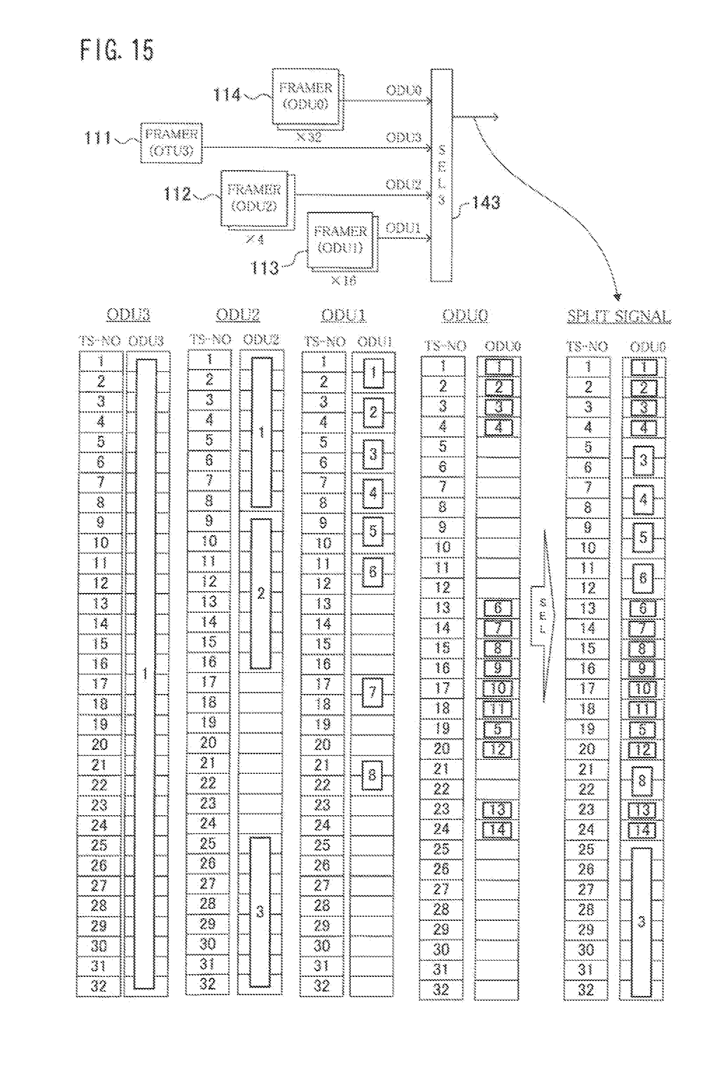

FIG. 15 illustrates input signals ODU0-ODU3 fed into the SEL module 143, and a split signal.

The SEL module 143 selects a TS from among ODU0 outputted from the ODU0-Framer 114, ODU3 outputted from the OTU3-Framer 111, ODU2 outputted from the ODU2-Framer 112, and ODU1 outputted from the ODU1-Framer 113, and deems the selected TS as an output signal.

The SEL module 143 feeds, thereinto, TS1-TS4, TS13-20, TS23, and TS24 from the ODU0-Framer 114, and feeds out the same as output signals TS1-TS4, TS13-20, TS23, and TS24.

The SEL module 143 feeds, thereinto, TS5-TS12, TS21, and TS22 from the ODU1-Framer 113, and feeds out the same as output signals TS5-TS12, TS21, and TS22.

The SEL module 143 feeds, thereinto, TS25-TS32 from the ODU2-Framer 112, and feeds out the same as output signals TS25-TS32.

### Second Embodiment

A multiplexer 200 according to the second embodiment performs a multiplexing process on the basis of TS instead of performing a multiplexing process for each ODU level.

The multiplexer 200 according to the second embodiment extracts TS's from inputted ODU signals at the individual levels, sorts the extracted TS's if necessary, creates ODU signals at necessary levels based on the sorted TS's, and multiplexes the created ODU signals, so that a desired ODU signal is created. Any of ODU0-ODU3 signals may be created if necessary. As with the case of the demultiplexer 100 of the first embodiment, the TS's are extracted in structural units of ODU corresponding to the smallest unit of ODU levels that are processable by the multiplexer 200.

The multiplexer 200 performs a multiplexing process on the basis of TS irrespective of ODU levels of ODU signals fed thereinto, so that the process steps are simplified and the functions are easily expanded.

Generating signals at the individual ODU levels from the TS's eliminates the need for multiplexing circuits for the individual ODU levels. Even if a new ODU level is standardized, a prompt response is possible by adding a Framer for the new ODU, or the like.

The following is a description of a multiplexer which receives an input of ODU0-ODU3 and outputs a 40 G signal. It is assumed that the multiplexer 200 deals with ODU levels of ODU0-ODU3.

[Configuration]

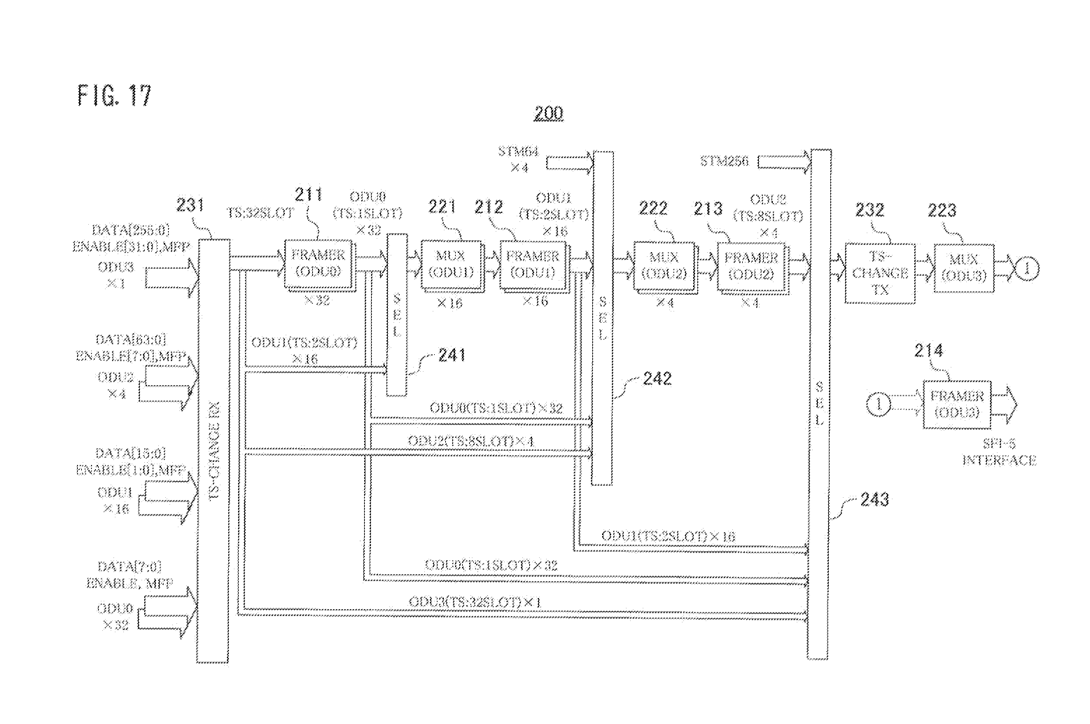

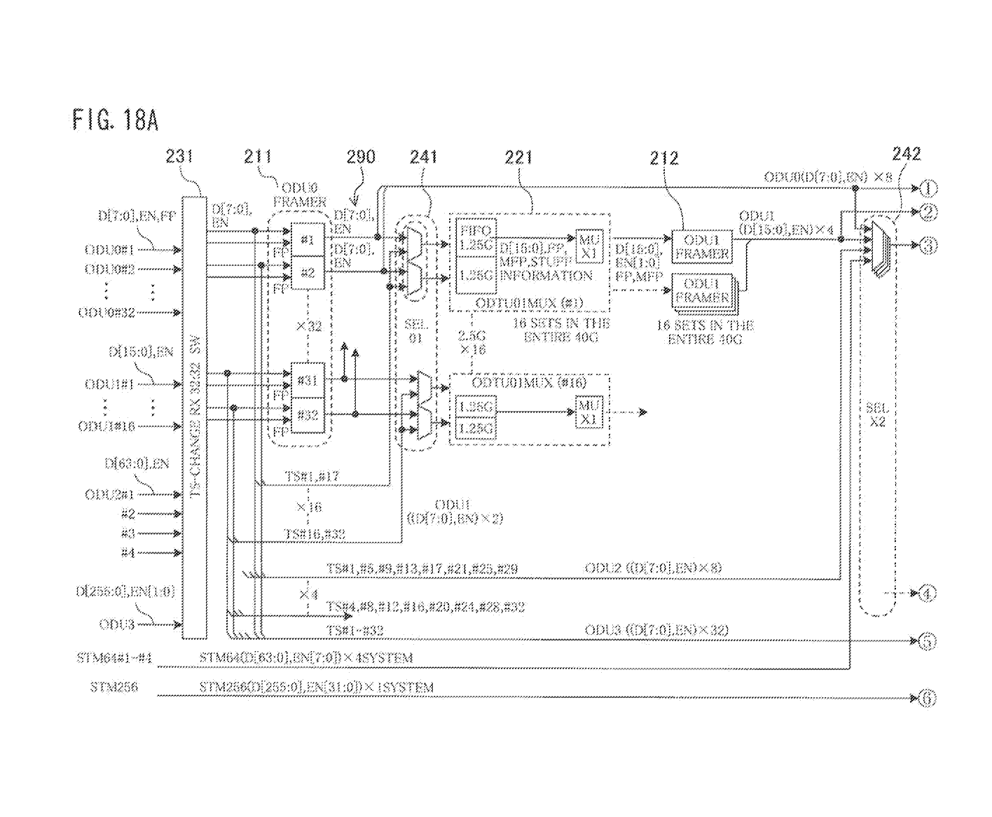

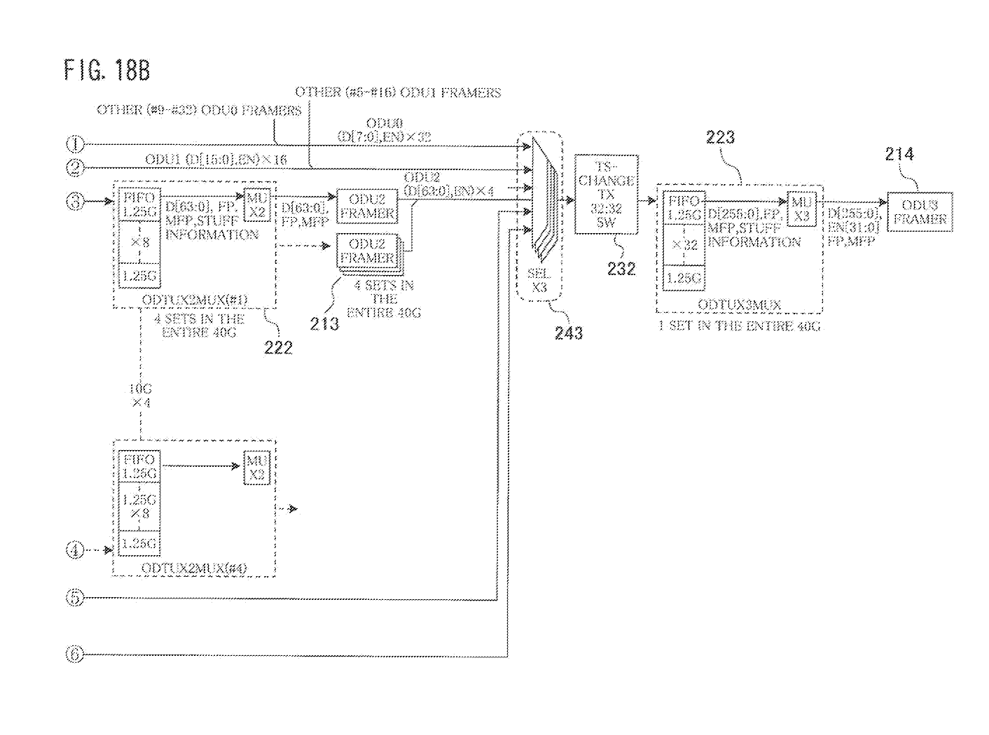

FIG. 17 is a diagram illustrating an example of the functional configuration of the multiplexer 200, and FIGS. 18A and 18B are diagrams illustrating an example of the detailed configuration of the multiplexer 200.

The multiplexer 200 is configured of Framers, Mux modules, TS-change modules, and SEL modules. These modules perform communication with a CPU through a register if necessary.

The Framers are 32 ODU0-Framers 211, 16 ODU1-Framers 212, 4 ODU2-Framers 213, and one ODU3-Framer 214.

The Mux modules are 16 ODU1-Mux modules 221, 4 ODU2-Mux modules 222, and one ODU3-Mux module 223.

The TS-change modules are one TS-change RX module 231, and one TS-change TX module 232.

The SEL modules are a SEL module 241, a SEL module 242, and a SEL module 243.

The multiplexer 200 receives inputs of the individual data signals and enable signals such as ODU0-ODU3, STM 64 and STM 256 in synchronism with a system clock of the multiplexer 200.

The TS-change RX module 231, first, splits each of ODU3-OD1 that are input data signals into 32-slot TS signals. To be specific, the TS-change RX module 231 generates TS's as data having a capacity corresponding to approximately 1.2 Gbps, i.e., data, enable signals, and synchronous signals corresponding to ODU0.

The TS-change RX module 231, then, selects necessary TS's from among the TS's obtained by the split, sorts the necessary TS's, and outputs the resultant. The selection and sort are performed in accordance with preset H/S information.

Each of the ODU0-Framers 211 receives an input of 1-slot TS signal, and creates an ODU0 frame signal in accordance with the ODU0 frame structure. To be specific, the ODU0-Framer 211 finds the front based on the input synchronous signal FP, inserts the OH of the ODU0 to create again an ODU0 frame. It is determined in advance which ODU0-Framer 211 is caused to perform processing on which TS outputted from the TS-change RX module 231. For example, it is determined in advance that the ODU0-Framer 211#1 is caused to perform processing on TS16 (see FIG. 18A or 18B).

As for processes performed by the ODU0-Framer 211 through the SEL module 243, a TS is fixedly allocated for each ODU level. For example, in the SEL module 241, TS signals inputted from TS1 and TS17 are arranged so as to be always outputted to the ODU1-Mux module 221#1. This is because the processes may be simplified by fixing the TS numbers to be inputted to the individual Mux modules, and handling TS's as one group. The allocation of TS's will be described later in [TS allocation by SEL module] section.

The SEL module 241 selects data to be sent to the individual ODU1-Mux modules 221. To be specific, the SEL module 241 performs the selection from among the ODU0 signal fed out from the ODU0-Framer 211 and the ODU1 signal fed out from the TS-change RX module 231.

Each of the ODU1-Mux modules 221 receives an input of 2-slot TS signals and performs a multiplexing process thereon. To be specific, the ODU1-Mux module 221 incorporates data having a capacity corresponding to 2.5 Gbps into a FIFO processing portion provided therein, and monitors a frequency deviation with an enable signal, i.e., performs a phase comparison between W and R, and a stuff detection process. After that, in a MUX processing portion provided in the ODU1-Mux module 221, the OH of OPU1 is inserted, and the resultant is fed out to the corresponding ODU1-Framer 212. The FIFO processing portion and the MUX processing portion are described later in [Configuration of FIFO processing portion and MUX processing portion] section.

The ODU1-Mux module 221 multiplexes the 2-slot TS signals, so that the same signal processing may be performed on ODTUO1 and ODU1.

Each of the ODU1-Framers 212 creates an ODU1 frame signal based on a signal fed out from the corresponding ODU1-Mux module 221. To be specific, the ODU1-Framer 212 creates, again, 16-bit parallel data, an FP, and an MFP.

The SEL module 242 selects data to be sent to the individual ODU2-Mux modules 222. To be specific, the SEL module 242 performs the selection from among the ODU0 signal fed out from the ODU0-Framer 211, the ODU1 signal fed out from the ODU1-Framer 212, and the ODU2 signal fed out from the TS-change RX module 231.

Each of the ODU2-Mux modules 222 receives an input of 8-slot TS signals and performs a multiplexing process thereon. To be specific, the ODU2-Mux module 222 incorporates data having a capacity corresponding to 10 Gbps into a FIFO processing portion provided therein, and monitors a frequency deviation with an enable signal. After that, in a MUX processing portion provided in the ODU2-Mux module 222, the OH of OPU2 is inserted, and the resultant is fed out to the corresponding ODU2-Framer 213.

The ODU2-Mux module 222 multiplexes the 8-slot TS signals, so that the same signal processing may be performed on ODTUO2, ODTU12, and ODU2.

Each of the ODU2-Framers 213 creates an ODU2 frame signal based on a signal fed out from the corresponding ODU2-Mux module 222. To be specific, the ODU2-Framer 213 creates, again, 64-bit parallel data, an FP, and an MFP.

The SEL module 243 selects data to be sent to the ODU3-Mux module 223. To be specific, the SEL module 243 performs the selection from among the ODU0 signal fed out from the ODU0-Framer 211, the ODU1 signal fed out from the ODU1-Framer 212, the ODU2 signal fed out from the ODU2-Framer 213, the ODU3 signal fed out from the TS-change RX module 231, and the STM 64.

The TS-change TX module 232 sorts the outputs from the SEL module 243, and feeds out the resultant to the ODU3-Mux module 223. The signals that have been subjected to the multiplexing process by the ODU3-Mux module 223 are eventually output signals from the multiplexer 200. Thus, the sorting is so performed that the order of the outputs from the SEL module 243 corresponds to the order of TS's of the eventual signals.

The ODU3-Mux module 223 receives an input of 32-slot TS signals and performs a multiplexing process thereon. To be specific, the ODU3-Mux module 223 incorporates data having a capacity corresponding to 40 Gbps into a FIFO processing portion provided therein, and monitors a frequency deviation with an enable signal. After that, in a MUX processing portion provided in the ODU3-Mux module 223, the OH of OPU3 is inserted, and the resultant is fed out to the corresponding ODU3-Framer 214.

The ODU3-Mux module 223 multiplexes the 32-slot TS signals, so that the same signal processing may be performed on ODTUO3, ODTU13, ODTU23, and ODU3.

The ODU3-Framer 214 creates an ODU3 frame signal based on a signal fed out from the ODU3-Mux module 223. To be specific, the ODU3-Framer 214 creates, again, 256-bit parallel data, an FP, and an MFP.

[TS-Change Module]

Each of the TS-change RX module 231 and the TS-change TX module 232 has the same configuration as that of the TS-change module 131, and the like of the demultiplexer 100 according to the first embodiment (see FIGS. 8 and 9).

As with the case of the demultiplexer 100, selection and sorting are set, based on the H/S information (see FIG. 10), in the TS-change RX module 231 and the TS-change TX module 232.

In the circuit of the demultiplexer 100 illustrated in FIG. 9, the line path is determined by allocating signals TS1-TS32 extracted by the Demux module to the registers corresponding to TS1-TS32 specified in the H/S information. In contrast, in the circuit of the multiplexer 200, the circuit path is determined by allocating signals TS1-TS32 multiplexed at a low-capacity ODU level.

[SEL Module]

Each of the SEL module 241, the SEL module 242, and the SEL module 243 has the same configuration as that of the SEL module 141 and the like of the demultiplexer 100 according to the first embodiment. As with the case of the demultiplexer 100, selection and sorting are set in the SEL module 241, and the like based on the H/S information.

[Configuration of FIFO Processing Portion and MUX Processing Portion]

The following is a description of the ODU1-Mux module 221, the ODU2-Mux module 222, and the ODU3-Mux module 223.

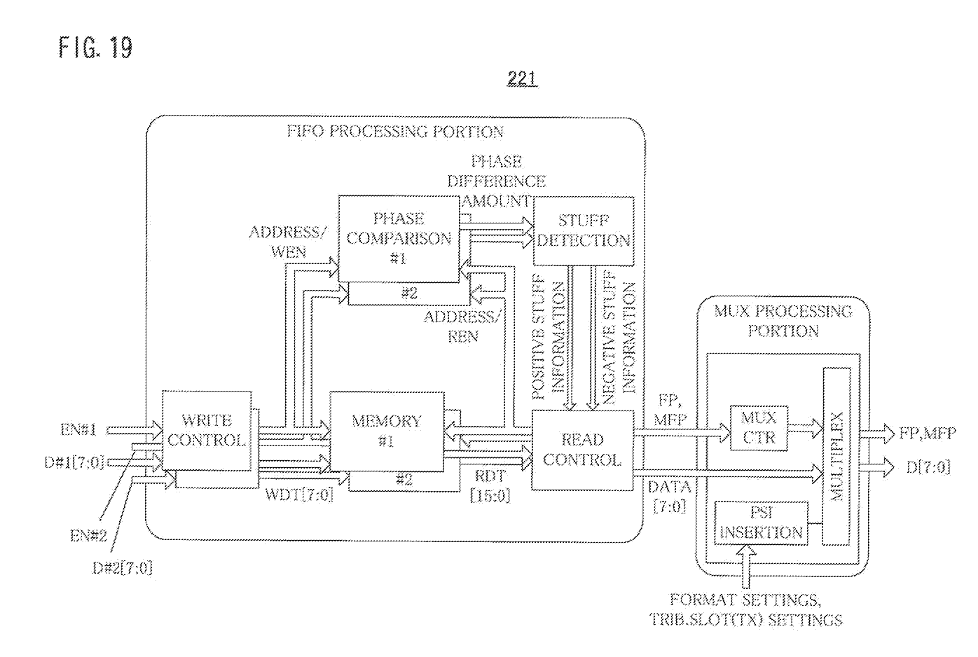

The description is given by taking an example of the configuration of the ODU1-Mux module 221 illustrated in FIG. 19.

The ODU1-Mux module 221 is configured of a FIFO processing portion and a MUX processing portion.

The FIFO processing portion is provided with a write control block, a memory block, a phase comparison block, a read control block, and a stuff detection block.

The individual system numbers of write control blocks, memory blocks, and phase comparison blocks correspond to ODU levels to be processed by the FIFO processing portion. To be specific, 2 systems of the write control blocks and so on are provided for the case of ODU1, 8 systems of the write control blocks and so on are provided for the case of ODU2, and 32 systems of the write control blocks and so on are provided for the case of ODU3. The number of read control blocks and stuff detection blocks provided in the ODU1-Mux module 221 is one each irrespective of the ODU levels to be processed by the FIFO processing portion.

Accordingly, two write control blocks, two memory blocks, and two phase comparison blocks are provided in the FIFO processing portion of the ODU1-Mux module 221 of FIG. 19.

Each of the write control blocks serves to perform a data writing process into a memory block.

Each of the write control blocks receives an input of Enable (EN) and data (D:[7:0]) from the SEL module 241 (see signal 290 of FIG. 18A or 18B).

The write control block generates a write address into the memory block and Enable based on the Enable (EN) inputted from the SEL module 241. The data (D[7:0]) inputted from the SEL module 241 is outputted as write data (WDT[7:0]) into the memory block.

Each of the memory blocks is a general memory such as a RAM.

The read control block serves to perform a data reading process from the memory block. The read control block is provided with a self-powered counter.

The read control block generates a reading address of the memory block and Enable based on the self-powered counter and information (negative stuff information or positive stuff information) detected by the stuff detection block.

The read control block feeds out the address and the Enable thus generated to the individual memory blocks and reads out data. In the case of the ODU1-Mux module 221, the address and the Enable are commonly used in the 2 systems.

The read control block feeds out the data (Data:[7:0]) read out from the memory block to the MUX processing portion. The read control block also creates an FP indicating the front of an ODU frame, or an MFP indicating the front of a multi-frame, and feeds out the resultant to the MUX processing portion.

When controlling a data reading process from the memory blocks with reference to the information detected by the stuff detection block, the read control block inserts NJO and PJO of OPU OH.

Each of the phase comparison blocks detects the amount of a phase difference based on the address and the Enable on the side of the write control block, and the address and the Enable on the side of the read control block, then to feed out the detected amount of the phase difference to the stuff detection block.

When receiving the detected phase difference amounts from the phase comparison blocks of the 2 systems, the stuff detection block adds the phase difference amounts together, and, based on the resultant value, feeds out the positive stuff information to the read control block if the read control block is faster than the write control block. Alternatively, if the write control block is faster than the read control block, then the stuff detection block feeds out the negative stuff information to the read control block.

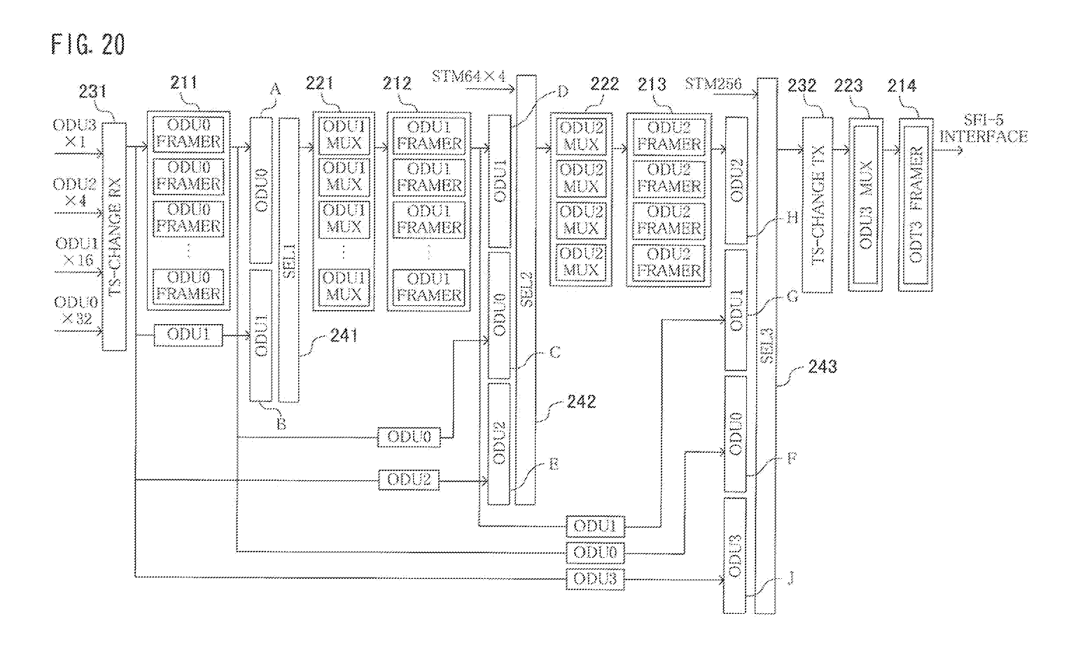

The MUX processing portion creates a frame counter based on the FP or the MFP received from the read control block, and inserts a PSI byte (MSI) of the OH of the OPU at a predetermined timing. This is performed based on the value of the ODU format settings made in the SEL module 241 or the value of the TS-change RX module 231 settings. The ODU format settings correspond to, among “ODU0 ODU0#(A)” settings described later with reference to FIG. 20, those settings that have been selected for performance. The TS-change RX module 231 settings correspond to, among “ODU1 TS#(B)” settings, those settings that have been selected.

[Allocation of TS's by SEL Modules]

FIG. 20 is a diagram illustrating an example of a TS signal flow in the multiplexer 200. FIG. 20 indicates ODU from which TS's to be sent to the ODU1-Mux module 221, the ODU2-Mux module 222, and the ODU3-Mux module 223 at the subsequent stages are selected respectively by the SEL module 241, the SEL module 242, and the SEL module 243.

The SEL module 241 performs the selection from among an ODU0 signal (A) outputted by the ODU0-Framer 211 and an ODU1 signal (B) outputted by the TS-change RX module 231.

The SEL module 242 performs the selection from among an ODU0 signal (C) outputted by the ODU0-Framer 211, an ODU1 signal (D) outputted by the ODU1-Framer 212, and an ODU2 signal (E) outputted by the TS-change RX module 231.

The SEL module 243 performs the selection from among an ODU0 signal (F) outputted by the ODU0-Framer 211, an ODU1 signal (G) outputted by the ODU1-Framer 212, an ODU2 signal (H) outputted by the ODU2-Framer 213, an ODU3 signal (J) outputted by the TS-change RX module 231, and the STM 64.

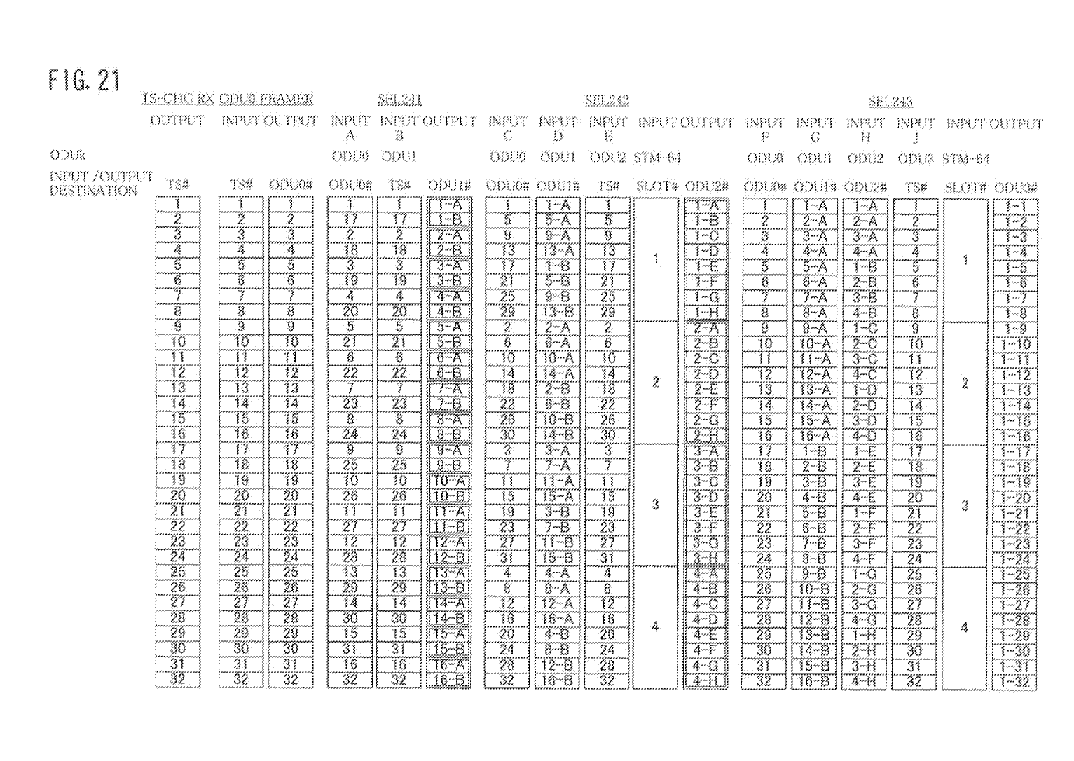

FIG. 21 is a list indicating settings of associations in which TS signals fed into the SEL modules and TS signals as output signals. Alphabets combined with the term “input” represent the ODU signals of FIG. 20. For example, “input A” represents the ODU0 signal (A) of FIG. 20.

Upon the performance, a presetting is so made that input signals are preselected in accordance with the list. For example, the input “ODU0 #” is selected as an input signal that is to be outputted as “1-A” of the output “ODU2 #” of the SEL module 242.

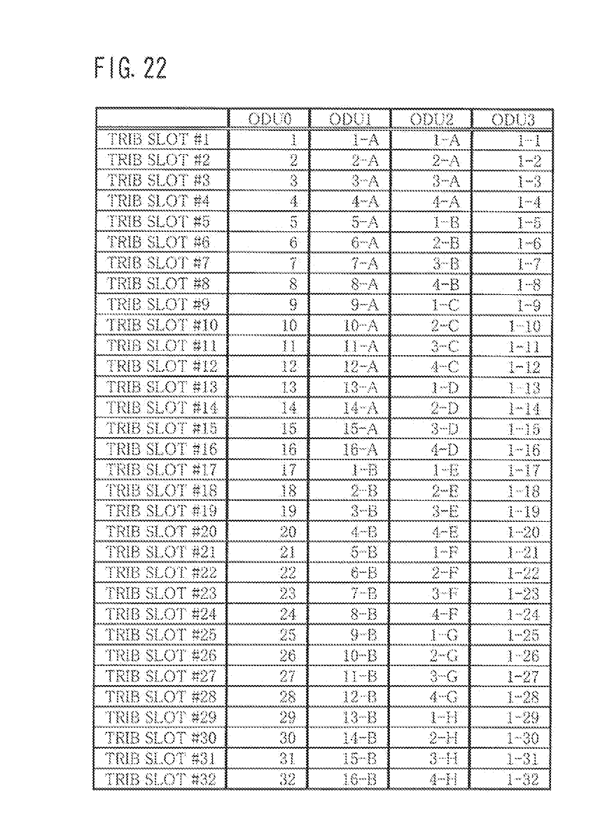

The list is an example described based on a positional correspondence table of TS's and ODU signals illustrated in FIG. 22. According to the correspondence table, for example, “ODU1 #7-B”, “ODU2 #3-G”, and “ODU3 #1-23” are fixedly assigned to TS23 fed out by the TS-change RX module 231. Further, “1-A” and “1-B” in the field of “ODU1” mean that two of “A” and “B” constitute one ODU1. Likewise, the table indicates that eight TS's of “A” through “H” constitute one ODU2.

Referring to the list of FIG. 21, the values in the rows of “output” are described in the order of TS number of TS's to be sent to the MUX module of a subsequent stage. For example, the list indicates that “1-A” and “1-B” in the output “ODU1 #” of the SEL module 241 sends to “#1” of the ODU1-Mux module 221. As exemplified in the list, “A” and “B” makes a pair. This indicates that the number of TS signals to be fed into the ODU1-Mux module 221 is two. This also indicates that the ODU1 is composed of two TS's.

Further, the values in the rows of “input” represent ODU signals as the corresponding inputs. For example, referring to the input “ODU0 #” of the SEL module 241, “17” means “17” of the output “ODU0 #” from the ODU0-Framer 211. The value “17” of the output “ODU0 #” is outputted as “1-B” of the output “ODU1 #”.

In addition, for example, “5-A” of the input “ODU1 #” of the SEL module 242 indicates a TS signal that has been fed out as “5-A” of the output “ODU1 #” from the SEL module 241, and is outputted as “1-B” of the output “ODU2 #”.

[Operation]

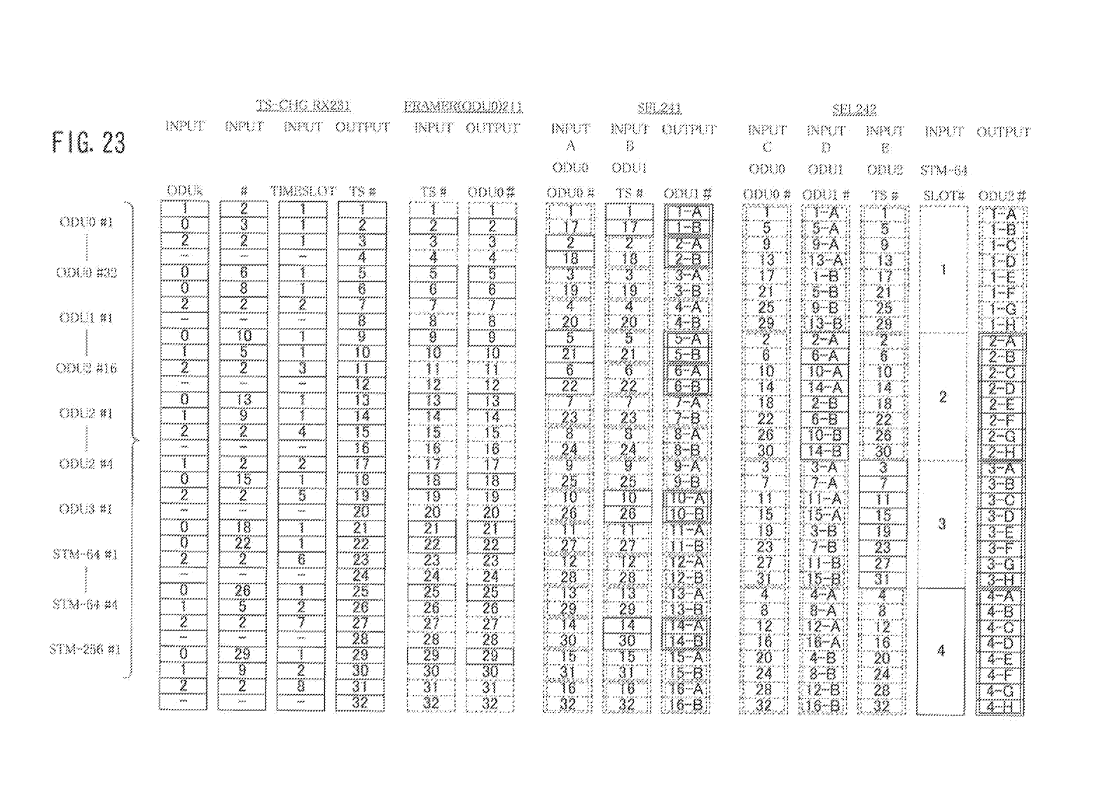

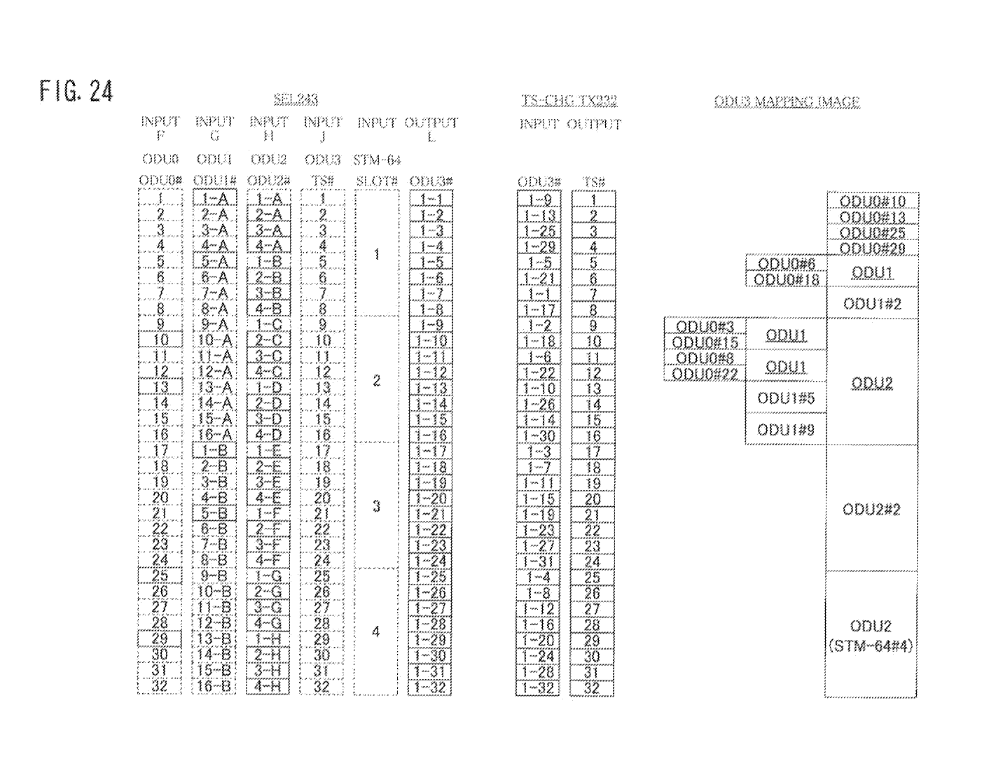

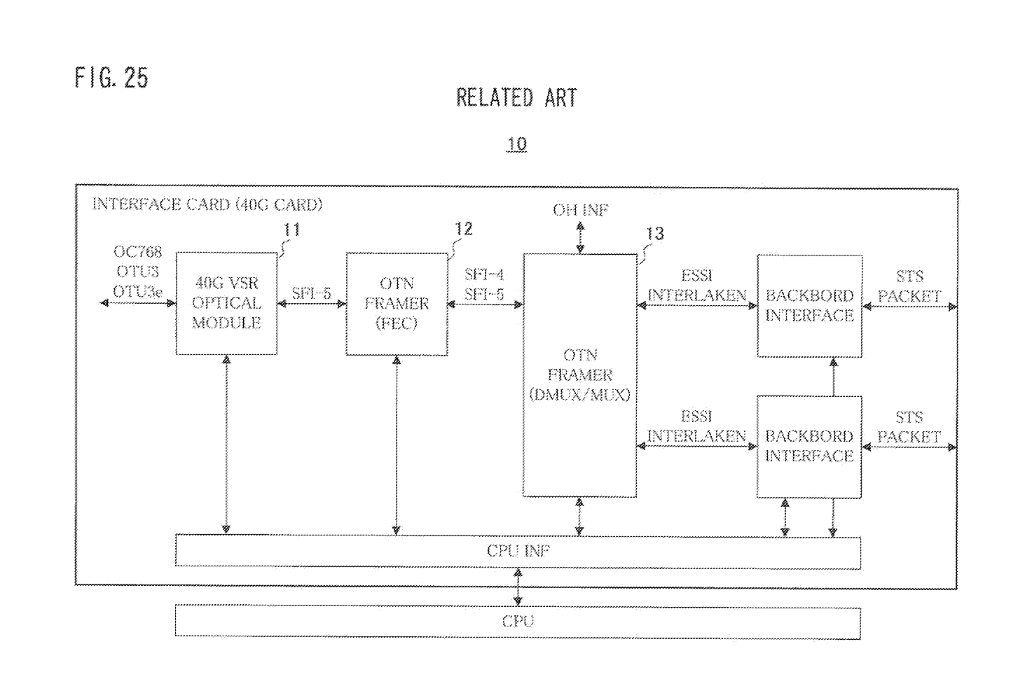

The following is a description of operation performed by the multiplexer 200 of this embodiment, with reference to FIGS. 23 and 24.

FIGS. 23 and 24 are specific data walk-through diagrams.

In FIGS. 23 and 24, signals selected from the list of FIG. 21 are indicated. It is assumed that settings surrounded by solid-line rectangles have been selected. The selection is performed by making settings of the H/S information (see FIG. 10).

As a specific example, process steps are described below in which the multiplexer 200 feeds, thereinto, ODU0-ODU3, the STM 64, and the STM 256 as source data, selects any data from the source data, and performs mapping into the ODU3 (see “ODU3 mapping image” of FIG. 24).

As the source data, ODU0#1 through ODU0#32, ODU1#1 through ODU1#16, ODU2#1 through ODU2#4, ODU3#1, STM-64#1 through STM-64#4, and STM-256#1 are inputted.

The TS-change RX module 231 selects any 32-time slots data from the ODU as the source data, and sorts the selected data.

Referring to the chart for the TS-change RX module 231, an ODU signal to be outputted to a TS indicated in the field of “output TS#” is specified in the field of “input”. To be specific, ODU levels, ODU numbers, and time slot numbers are respectively specified as “input ODUk”, “input #”, and “input Time Slot”. For example, a signal to be outputted as a TS having “1” in the “output TS#” field is an ODU1#2 signal and a time slot 1 signal because “1”, “2”, and “1” are respectively indicated in “input ODUk”, “input #”, and “input Time Slot”. A signal having ODU1#2 and time slot 2 is outputted as a TS having “17” in the “output TS#” field. The ODU1 is composed of two TS's “1-A” and “1-B” as illustrated in FIG. 22. The alphabets “A” and “B” correspond to time slot.

In this specific example, there are some unused slots indicated as “-” in FIG. 23 because mapping of STM data is performed.

With the TS-change RX module 231, in the case where the arrangements of 32 TS's in the lane demapping output, i.e., the arrangement for the case of extracting TS's from input ODU0-ODU3 is different from the arrangement of TS's expected in MUX processing of a subsequent stage, arrangement conversion is performed. This is because how to deal with TS's is fixed in the Mux processing. The TS# for the lane demapping output is set with TS of “output TS#” set as the output destination. In this specific example, a case is described in which no such conversion is necessary.

The ODU0-Framer 211 feeds, thereinto, an ODU0 signal from a TS of “output TS#” corresponding to an input ODU having “0” in “input ODUk” of the TS-change RX module 231, generates an ODU0 frame signal, and feeds out the ODU0 frame signal. In this specific example, ten ODU0 signals having values of “2”, “5”, “6”, “9”, “13”, “18”, “21”, “22”, “25”, and “29” in the “input TS#” are created and outputted.

The SEL module 241 selects data to be sent to the ODU1-Mux module 221.

There are 16 systems of the ODU1-Mux modules 221, and therefore, ODU levels of input data corresponding to the individual ODU1-Mux modules 221 are selected.

Setting is made as to whether “inputA ODU0 ODU#” and “inputB ODU1 TS#” are effective or not with “output ODU1#” set as the output destination.

Settings surrounded by solid rectangles are made effective.

For example, “1” and “17” are made effective in “input ODU1 TS#” for “1-A” and “1-B” indicated in “output ODU1#”.

The SEL module 242 selects data to be sent to the ODU2-Mux module 222.

There are 4 systems of the ODU2-Mux modules 222, and therefore, ODU levels of input data corresponding to the individual ODU2-Mux modules 222 are selected.

Setting is made as to whether “inputC ODU0 ODU0#”, “inputD ODU1 ODU1#”, “inputE ODU2 TS#”, and “input STM-64 Slot#” are effective or not with “output ODU2#” set as the output destination.

For example, “2-A”, “6-A”, “10-A”, “14-A”, “2-B”, “6-B”, “10-B”, and “14-B” are made effective in “inputD ODU1 ODU1#” for “2-A” through “2-H” indicated in “output ODU2#”. Further, “4” is made effective in “input STM-64 Slot#” for “4-A” through “4-H” indicated in “output ODU2#”.

The SEL module 243 selects data to be sent to the ODU3-Mux module 223.

Setting is made as to whether “inputF ODU0 ODU0#”, “inputG ODU1 ODU1#”, “inputH ODU2 TS#”, “input) ODU3 TS#”, and “input STM-64 slot#” are effective or not with “output ODU3#” set as the output destination.

For example, “1-A” is made effective in “inputG ODU1 ODU1#” for “1-1” indicated in “output ODU3#”.

In the case where the arrangement of 32 TS's to be outputted by the SEL module 243 is different from the arrangement of TS's of ODU3 data externally outputted, the TS-change TX module 232 performs the arrangement conversion. This is because how to deal with TS's is fixed in the ODU3-Mux module 223.

A TS of ODU3 outputted by the SEL module 243 is set in “input ODU3#” with “output TS#” set as the output destination.

In the end, ODU3 such as that illustrated in “ODU3 mapping image” of FIG. 24 is generated. In the image, the ODU numbers are the same as those of ODU numbers of the source data, and underlined ODU have been subjected to the multiplexing process internally.

Although the embodiments have been described above, the present invention is not limited thereto. The following arrangement is possible.

In the embodiments described above, the description is provided of a demultiplexer and a multiplexer for ODU frames in an OTN. The embodiments are, however, applicable to a demultiplexer and a multiplexer for transmission data in other transport networks.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An interface device for demultiplexing, from a first frame in a transport network, a plurality of second frames multiplexed into the first frame, the interface device comprising:
an extractor configured to extract a plurality of data groups to constitute the first frame; and
a second frame generator configured to create the second frames based on the plurality of data groups extracted by the extractor.

2. The interface device according to claim 1, wherein
a plurality of the second frame generators are provided by an amount to multiplex the second frames into the first frame, and
the interface device further comprises a sorting portion that sorts the plurality of data groups extracted by the extractor in such a manner that a plurality of data groups to constitute the second frames are fed into the individual second frame generators.

3. The interface device according to claim 2, wherein no current is supplied through a circuit for running at least one of the second frame generators that does not receive an input of the plurality of data groups sorted by the sorting portion.

4. The interface device according to claim 1, further comprising a third frame generator configured to create a third frame multiplexed into the first frame or the second frame based on the plurality of data groups extracted by the extractor.

5. The interface device according to claim 1, wherein a unit of the plurality of data groups to be extracted by the extractor is a unit according to which a frame that is multiplexed at a smallest level into the first frame is structured by one data group.

6. An interface device for multiplexing a plurality of frames in a transport network to create a first frame, the interface device comprising:
an extractor that extracts, from the plurality of frames, a plurality of data groups to constitute each of the plurality of frames; and
a first frame generator configured to select a data group to constitute the first frame from among the plurality of data groups extracted by the extractor, and creates the first frame based on the data group thus selected.

7. The interface device according to claim 6, wherein
a plurality of second frames are multiplexed into the first frame,
the interface device further comprises at least one second frame generator configured to create the second frames based on the plurality of data groups extracted by the extractor, and
the first frame generator configured to create the first frame based on the second frames created by said at least one second frame generator, and the plurality of data groups extracted by the extractor.

8. The interface device according to claim 7, wherein
a plurality of the second frame generators are provided by an amount to multiplex the second frames into the first frame, and
the interface device further comprises a sorting portion configured to sort the plurality of data groups extracted by the extractor in such a manner that a plurality of data groups to constitute the second frames are fed into the individual second frame generators.

9. The interface device according to claim 8, wherein no current is supplied through a circuit for running at least one of the second frame generators that does not receive an input of the plurality of data groups sorted by the sorting portion.

10. The interface device according to claim 6, wherein a unit of the plurality of data groups to be extracted by the extractor is a unit according to which a frame that is multiplexed at a smallest level into the first frame is structured by one data group.

11. The interface device according to claim 1 or 6, wherein
the transport network is an Optical Transport Network (OTN comformable to ITU-T G.709), and the frame is an Optical channel Data Unit (ODU) frame, and
each of the plurality of data groups extracted by the extractor is a Tributary Slot.

12. A demultiplexing method used in an interface device for demultiplexing, from a first frame in a transport network, a plurality of second frames multiplexed into the first frame, the demultiplexing method comprising:
causing the interface device to extract a plurality of data groups to constitute the first frame; and
causing the interface device to create the second frames based on the plurality of data groups thus extracted.

13. A multiplexing method used in an interface device for multiplexing a plurality of frames in a transport network to create a first frame, the multiplexing method comprising:
causing the interface device to extract, from the plurality of frames, a plurality of data groups to constitute each of the plurality of frames; and
causing the interface device to select a data group to constitute the first frame from among the plurality of data groups thus extracted, and to create the first frame based on the data group thus selected.
